(19) United States
(12) Patent Application Publication
(10) Pub. No.: US 2007/0005734 A1
(43) Pub. Date: Jan. 4, 2007

(54) Generically extensible client application

(75) Inventor: Nadim Y. Abdo, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/172,383

(22) Filed: Jun. 30, 2005

(51) Int. Cl. G06F 15/16

(52) U.S. Cl. 709/219

(57) ABSTRACT

A generically extensible client application has a modular core component configured to provide a client functionality. The client application also has one or more modular non-core components loosely coupled to the core to augment the client functionality and which are not directly referenced by the core component. Communication between the non-core components and the core component is facilitated by an event system configured to publish events related to the core component and configured to allow the non-core components to receive the published events. The communication is also facilitated by a property system configured to centralize access to properties related to the core component. The communication is further facilitated by a plug-in system configured to load non-core components and to facilitate communication between non-core components and the event system and the property system such that the non-core components have a similar level of access to events and properties as is available to the core component.

### BACKGROUND

Existing client application architectures tend to customize core code for each specific client product profile. Such architectures force each product profile to be subjected to extensive and time consuming reliability testing before release. In essence, such architectures forfeit much of the history established with existing client product profiles since the changes to the core's code essentially create a new core for each product profile. For instance, to achieve a specific new functionality, appropriate code is either added to the code or specifically referenced within the code. Such architectures result in slow and expensive development of new or revised product profiles.

### SUMMARY

A generically extensible client application has a modular core component configured to provide a client functionality. The client application also has one or more modular non-core components loosely coupled to the core to augment the client functionality and which are not directly referenced by the core component. Communication between the non-core components and the core component is facilitated by an event system configured to publish events related to the core component and configured to allow the non-core components to receive the published events. The communication is also facilitated by a property system configured to centralize access to properties related to the core component. The communication is further facilitated by a plug-in system configured to load non-core components and to facilitate communication between non-core components and the event system and the property system such that the non-core components have a similar level of access to events and properties as is available to the core component.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1-2 illustrate an exemplary system for implementing a generically extensible client application in accordance with one implementation.

FIG. 3 illustrates an exemplary process diagram for extending a client application in a generic manner in accordance with one implementation.

FIG. 4 illustrates an exemplary generically extensible client application architecture in accordance with one implementation.

FIG. 5 illustrates a portion of an exemplary generically extensible client application architecture, in the form of a property set tree, in accordance with one implementation.

FIG. 6 illustrates a portion of an exemplary generically extensible client application architecture in accordance with one implementation.

FIG. 7 illustrates exemplary systems, devices, and components in an environment for enabling a generically extensible client application in accordance with one implementation.

### DETAILED DESCRIPTION

Overview

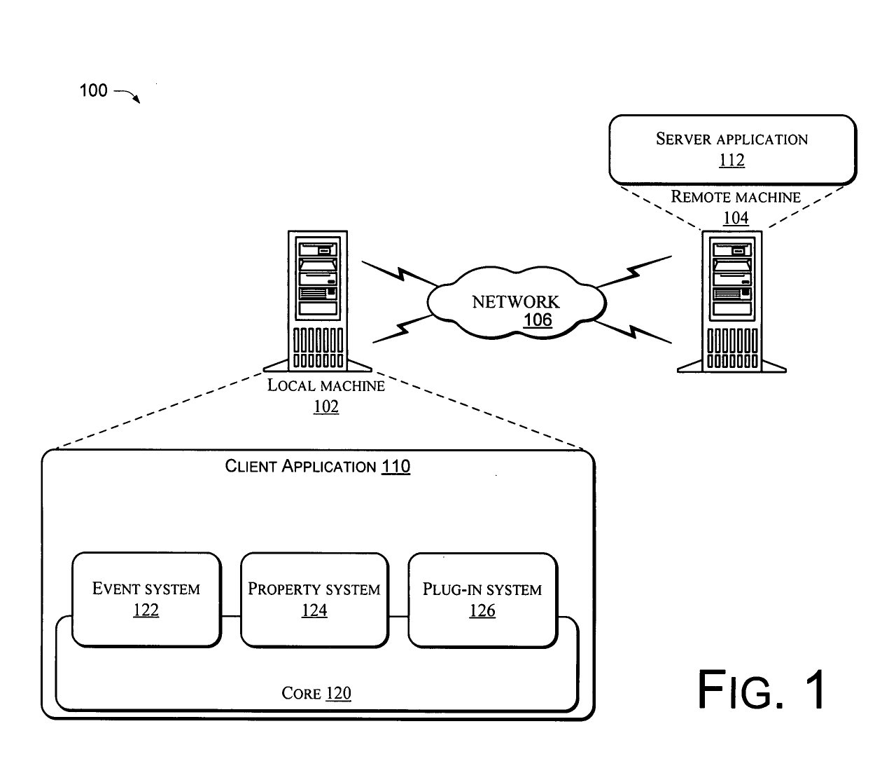

FIG. 1 illustrates an exemplary system 100 upon which a generically extensible client application can be implemented. System 100 includes a local machine 102 and a remote machine 104 which are communicably coupled over a network 106. A client application 110 operates on local machine 102 and a server application 112 acts as a counterpart to client application 110 on remote machine 104. The client application 110 and the server application 112 are configured to collectively achieve a desired functionality for a user of local machine 102. For instance, the client application and server application may achieve a remote terminal session functionality where a representation of a graphical window operating on the remote machine is remoted to the local machine over network 106 and displayed on local machine 102. In another instance, the client and server applications may achieve an internet browser functionality for the user. Other examples should become apparent from the description below.

Client application 110 achieves a particular functionality through a core 120, an event system or event model 122, a property system or property model 124, and a plug-in system or plug-in model 126. Core 120 is an extensible technology which provides a set of services related to a desired functionality, such as the remote terminal session or internet browser functionalities described above. The core is extensible in that it defines generic extensibility points to which other components of the application can bind. The extensibility points are generic in that the event system 122 is configured to fire events which may be of interest to one or more non-core components involved in achieving the desired client application functionality and/or an enhanced client application functionality. For instance, the desired functionality may offer a basic client application product profile, or in another instance the desired product profile may provide a more robust or enhanced client application product profile.

The property system 124 is configured to centralize access to core properties in an extensible way. The property system is also configured to provide services such as property validation and to provide event notifications to which components, such as pluggable components (herein, “plug-ins”), can bind. The plug-in system 126 provides a plug-in loading mechanism such that loaded plug-ins have access to the services described above and below in relation to core 120, event system 122, and property system 124.

Exemplary System Architectures

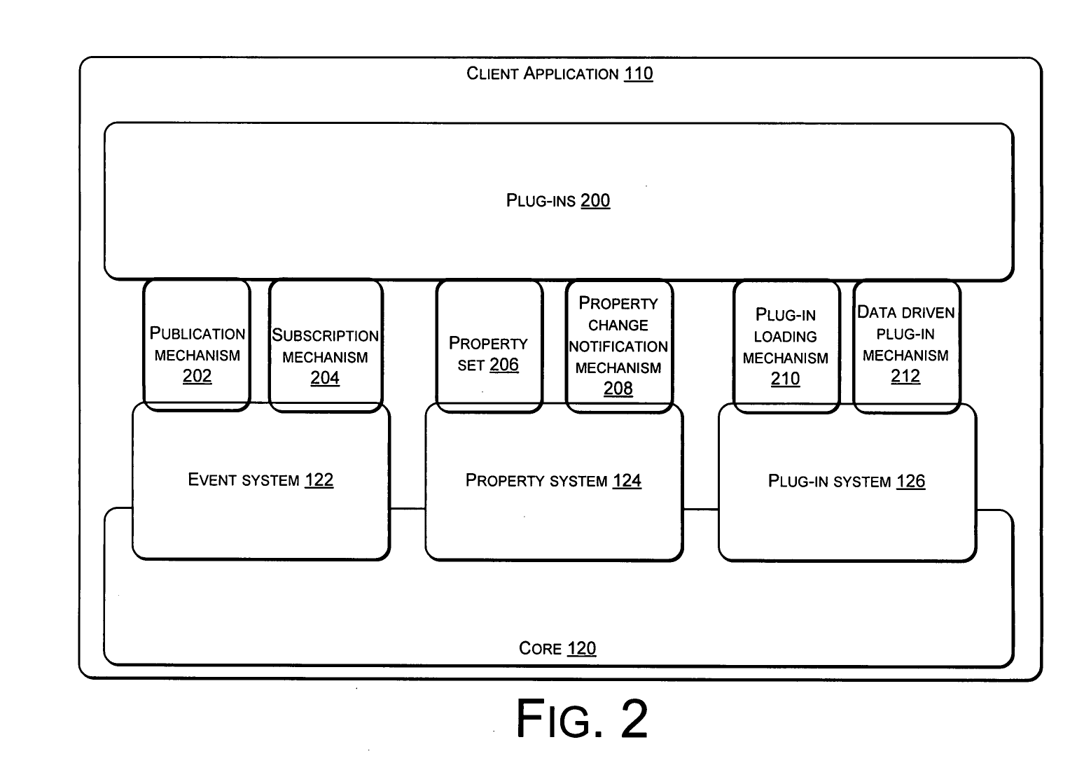

For purposes of explanation consider collectively, FIGS. 1-2 in order to appreciate architectural features of client application 110. As is described in more detail below, client application 110 provides an example of a generically extensible architecture for achieving a desired client application functionality.

In this instance, client application 110 achieves a configurable architecture through core 120, event system 122, property system 124, and plug-in system 126. One ore more pluggable components or plug-ins 200 are enabled by the event system, property system, and plug-in system to operate cooperatively with the core 120 to achieve the desired functionality. Core 120 is generically extensible to interact with selected plug-ins 200 via the event system 122, property system 124, and plug-in system 126. The core is generically extensible, at least in part, in that the core's code does not reference which plug-ins 200 are to receive specific events of the core. Such a configuration allows the same core to be utilized to accomplish a thin client product profile with a first set of plug-ins and a rich client product profile with a second set of plug-ins without changing the core's code. In contrast, the client application's product profile can be altered simply by selecting a given set of plug-ins to operate on top of the core.

Core 120 has an architecture where there are interfaces, such as com-like interfaces, throughout the core for access to potentially important things. The com-like interfaces are generic in that they do not limit access to predetermined components. So for instance, new plug-ins can be developed which can access the interfaces via the property system in the same way as a plug-in which was available when the core's code was written. The interfaces relate to core properties and are accessed by any interested plug-in via the property system.

Event system 122 provides a mechanism for any interested component to arbitrarily listen to events and to bind to the event if desired. In this implementation, event system 122 is configured to generically fire events of the core's generic extension points. In some instances, the event system includes a publication mechanism 202 and a subscription mechanism 204. The publication mechanism 202 is configured to publish events on behalf of the core as well as various non-core components of client application 110. For instance, an extension point of the core may provide a keystroke event to the event system. The event system's publication mechanism 202 then supplies the event to any interested client application component.

Subscription mechanism 204 is configured such that components can request to receive events relating to specified extension points. In this instance, the publication mechanism and the subscription mechanism serve to decouple the source of an event from a sink or consumer of an event. For instance, core extensibility points which generate events need not be aware of which, if any, components receive the events and no reference need be contained in the core's code. Similarly, the subscribing components need not be aware of where a published event originated.

In this instance, publication mechanism 202 is configured to supply events to any component interested in the event. Subscription mechanism 204 includes a subscription list which lists components which are interested in a particular type of event which may be published. So any component, such as plug-ins, can come along and say I am interested in this category or type of events. Please bind my sink (or callback) to these events. For instance, assume that in a remote terminal session scenario, a seamless window plug-in or an input plug-in specifies to the subscription mechanism 204 that it is interested in keyboard events. These plug-ins are added to the subscription list in relation to keyboard events. When the event system receives a keyboard event, the publication mechanism 202 maps to the subscription mechanism 204 and the keyboard event is published to the seamless window plug-in and the input plug-in. The event system 122 handles associated logistics of marshalling the appropriate event call to the appropriate plug-in address. In some instance, the event system is further configured to provide additional functionality such as transporting the event from one processing thread context to another. In such implementations a source of an event need not know anything about what happens to the event after the source provides the event to the event system. As such, event system 122 is configured to provide loose coupling between the generic extensibility points, such as those of the core, and those components associated with the application(s) which desire to bind to the extension points.

For purposes of explanation consider the following example in an RTS scenario. Further, assume that a plug-in wants to enable the client to run in a special mode e.g. full-screen in response to a particular key-combination that is pressed within the core. Utilizing the loose-coupling of the event system 122 the plug-in can just bind to a keyboard notification event that is fired whenever the keyboard input sub-system of an RTS client receives a key press. In response to the keyboard notification the plug-in can detect a key sequence of interest and make the appropriate action take place. All these actions occur without the core having to be changed to be aware of either the plug-in or the new mode. In contrast, previous designs require a specific callout to be added to the keyboard processing code to detect the key sequence of interest, thus coupling a portion of the ‘core code’ with what is really an ‘extension’ plug-in.

In another example, such as a graphics scenario, the extensibility point sends an object which encapsulates, for instance, what was drawn on a local computer, what are the clippings of what was drawn, what are the references to where it was drawn, among others to the event system 122. The event system sends the object to interested components as defined by the subscription list. By sending the object rather than simply a description of the event, the event system enables an interested subscriber to bind to the object. Further, since the object is actually passed to the subscriber, the subscriber can modify the object. Further, the subscriber may consume the object such that the object is not further transferred. For example, when a graphics update occurs, an event may be sent to a subscriber saying that a particular region of the display has changed. The subscriber may also receive an object that has a reference to the bit maps that have changed and various other information, such as the clipping region. The subscriber which receives that object can then change the object. For instance, assume for purposes of explanation, that the subscriber is a security plug-in that decides that the region of the screen that was changed is sensitive and should not be displayed. The security plug-in may for instance, draw over those regions, put hash marks over them, write top secret etc. so that the regions are not displayed. In such an instance, if the event is returned from the subscriber the data has changed. In another example, an accessibility plug-in may choose to magnify graphics or change color schemes to provide better contrast for a user.

The property system 124 serves to centralize access to properties, such as properties of the core, in an extensible way. The property system offers an avenue for components, such as plug-ins 200, to access the client application 110. The plug-ins can interact with the property system in a central fashion rather than having to attempt to identify and interface individual, potentially distributed points of the core 120 and/or other plug-ins 200. Such a configuration facilitates system interoperability regardless of the source of the various plug-ins 200 and/or the core 120. For instance, in one scenario the core and the plug-ins may be written by a single party, whereas in another configuration, the core may be written by one party while some or all of the plug-ins are written by a different party. The centralized property access provided by the property system 124 facilitates interoperability and system reliability since both the core 120 and the plug-ins 200 need have less intimate knowledge of the other than with existing configurations.

The property system 124 is further extensible in that it allows properties to be read and written in a decoupled manner such that an extensible point of the core 120 associated with a property writes or sends the property to the property system where it can be read by any components of the client application 110 which so desire. The components which read the property do not need to know which component wrote the property or even how to contact that component. In one such example, property system 124 is configured to list the properties in a property set 206 which is available to client components.

In addition to listing the properties, some implementations may further list property validation rules associated with individual properties of the property set 206. Such property validation rules can be supplied by the component providing the property. Commonly, the property validation rules are established in relation to the core's extensibility points. Other instances are described below.

In some implementations, property validation rules are enforced through an extensible data driven declaration for the properties. For example, the data driven declaration may specify that a given property is a number and that a value of the number should fall within a particular range, or for instance that the property is a string and that the string should have a value which is a certain length. In one instance, the data driven declaration is manifested as a table which lists all the properties of the client core and the validation rules around those properties. Based upon the table, the property system 124 validates values which satisfy the property's rules and invalidates any values which do not satisfy the property's rules.

Whenever a component attempts to change a property value, the property system 124 is configured to compare the proposed new value to the property validation rules. If the proposed new value falls within the validated property rule values, the property system will allow the change, otherwise the property system invalidates the proposed new property value.

For instance, assume that a given property relates to a server name. The property system contains the property validation rules associated with that property. For example, the property validation rules may recite that the server name property has to be a string and the string has to be of a particular maximum length. For purposes of a second example, assume that the property defines maximum color depth relative to the application's graphical window. For instance, in a 32 bit scenario, the associated property validation rules may state that the color depth has to be a number and that the number has to be less than 32. The property validation rules may further stipulate that the number can only be, for instance, 8, 16, or 32. This aspect of the property system allows interested components to review the client application's properties, and valid values for properties. Similarly, this aspect of the property system provides a mechanism for rejecting or invalidating property values which do not satisfy the associated property rules. Such a configuration reduces incidences of an inconsistent condition being created within the client and as such contributes to client reliability.

In some instances, where a particular property is more complex than, for example, a number or a string as mentioned above, the property system 124 is extensible to handle the property. In some of these instances the property system may establish a validation module for a given property. The validation module can be called whenever a change to the property is proposed to avoid introducing an inconsistent state within the client application. The validation module may be configured to analyze more detailed scenarios which may produce an inconsistent client state.

The property system 124 allows plug-ins 200 to become aware of, and to monitor, a present state of properties of the core and/or other plug-ins. In one such instance, the property system includes a property change notification mechanism 208 available to the plug-ins 200 and which is configured to provide notification relating to property changes. The property system also allows the plug-ins to influence or modify properties established by other components and/or to establish additional properties. The validation feature allows plug-ins to attempt to modify properties without fear of creating an inconsistent state since the validation feature invalidates property values which fall outside the property's validation rules.

In at least some implementations, the property system 124 also interfaces with the event system 122 to allow subscription to pre and/or post change notifications for any property or group of properties. So for instance, a component can request to be informed when a connection property, such as the server name, is about to change. By providing pre-notification to a property change the subscribing component has an opportunity to try to influence such a change before the change is implemented. For instance, a notification comes to a subscribing component that the server is going to change from a hypothetical value AA to a hypothetical value BB, the subscribing component may say no, instead change the server to a hypothetical value CC instead of value BB. For instance, assume that a security plug-in is enforcing that the client application only connects to a server within an organization. Further assume that another component wants to change the server to myserver.myorganization.com. The security component is subscribed to receive a pre-change notification and can inspect the request to determine if the request satisfies its conditions.

For purposes of explanation, consider the following example in a remote terminal session scenario. The property system 124 allows a plug-in 200, such as a seamless window plug-in to inspect any of the currently set properties through property set 206. So for instance, the seamless window plug-in can query the current state of the full screen property. Further, assume that the full screen property is a Boolean property in that the current state of the client application 110 is full screen is true or full screen is false. So this is an extension point from the sense that the seamless window plug-in can now interface with the rest of the core in a clean way. For instance, the seamless window plug-in does not have to go directly to whatever the internal object is that manages the full screen property and the seamless window plug-in does not even need to know about that internal object, instead it can just go to the property system 124 that represents the state of the core 120 and inspect it in an extensible way and query what is the current state of the full screen property? The seamless window plug-in may determine a course of action responsive to the query result. For instance, the seamless window plug-in may request to change the property. For example, the seamless window plug-in may request of the property system to make the full screen property false.

Further, in at least some implementations, the event system 122 and the property system 124 are configured to work together to facilitate the overall client application functionality. So for instance, a plug-in 200 may request that the property system's property change notification mechanism 208 forward an event whenever a property, such as the full screen, is changed. Further still, in some implementations, the property system allows a pre-change notification and a post-change notification and provides the opportunity for the plug-ins to influence the change before it happens. So for instance, the property system 124 can say the full screen property is about to change, plug-ins 200 can bind to that notification and say no I don't want it to change or can do other actions in response that allows a plug-in to bind to a request to change a property before the change is implemented. For instance, in the seamless window example, the plug-in may request to be called wherever a request is made to change the full screen property. This feature provides an opportunity for the plug-in to influence whether the proposed change is implemented. So continuing the seamless window example, if a request is received to make the full screen property true, the seamless window plug-in becomes aware of the requested change and can try to influence the property. As such, this system allows plug-ins to be aware of properties and changes to those properties, and to be able to change the behavior that would happen without actually changing the core.

In some implementations, the extensible nature of the property system 124 further allows plug-ins 200 to specify new properties and associated property rules. For instance, a plug-in may specify three new properties and specify that the three properties have respective hypothetical property validation rules x, y, and z. The new properties and associated property validation rules can be added to the property set 206. Further, in at least some configurations, the new properties receive the same benefits from the infrastructure as those properties that are added ahead of time to the core 120.

To summarize the property system 124, rather than having properties spread throughout different objects in the core 120, the properties are owned and managed by the property system. The property system further provides an extension point relative to the properties. Plug-ins 200 can come in and bind to this extension point, can see what the properties are, can receive notifications regarding changes to the properties, can change the properties, and can provide new properties. The property system also serves to maintain consistency of state of the client application 110 in that the property system will invalidate any properties which lie outside the property's validation rules.

The plug-in system 126 is configured to load object modules, such as plug-ins 200, into the client application 110. The plug-in system provides a mechanism or means for loading plug-ins and facilitates the loaded plug-ins access to the services described above and below in relation to the core 120, the event system 122, and the property system 124. In this instance, a plug-in loading mechanism 210 facilitates loading plug-ins. As mentioned above, at least some implementations allow the core's code to be maintained for multiple client product profiles. For instance, the same core can be utilized to construct a thin client product profile as well as more robust client product profiles. The plug-in system 126, in combination with the event system 122 and the property system 124, provides clear interfaces, extension points, and a mechanism for communication with the core 120. The plug-in system 126 allows plug-ins 200 to be selected to operate cooperatively with the core 120 to create a desired client application product profile.

The plug-in system 126 provides means for opting in specified plug-ins at link time to create a specific client application product profile. Stated another way, in at least some implementations, the plug-in system allows the product profile to be determined at link time based upon which plug-ins 200 are included. For instance, in some implementations, the plug-in system offers a data driven plug-in mechanism 212 to facilitate creating the desired client application product profile. The data driven plug-in mechanism 212 can be manifested as a data driven text file upon which plug-ins for a specific client application product profile are listed. As such, the plug-in system 126, in combination with the event system 122 and the property system 124, allows a different product profile to be created simply by changing the plug-ins 200 listed on the data driven text file.

For purposes of explanation, the above description is characterized in relation to individual plug-ins. However, in at least some implementations, the plug-in system 126 is configured to handle component groups rather than individual plug-ins. For instance, the plug-in system, such as in the data driven plug-in mechanism 212, may contain a reference table which specifies all of the loaded plug-ins. The reference table may then reference a first sub-set of plug-ins to link to achieve a first client application product profile, and a second sub-set of plug-ins to link to achieve a second client application product profile. In such a scenario, some plug-ins may be included in both sub-sets while other are not included in either sub-set.

The plug-in loading mechanism 212, stated another way, abstracts away where plug-ins originate. In one case plug-ins can be external modules such as dynamic linked libraries (DLLs) that are specified to the client at runtime in some passed-in configuration such as a registry key. Such a configuration can be utilized to allow third party or future extensibility of the client after a particular client product has shipped to consumers. Such a configuration can be beneficial in that the plug-in loading mechanism 212 allows different client binaries to be built for different scenarios, e.g. a very slimmed-down and minimal client for a low-end embedded device to a very rich and full featured client for a powerful desktop PC. In order to allow the later case, the plug-in system 126 allows plug-ins 200 to be optionally specified at link-time. To enable such link time specificity, the plug-in system creates a stub entry point for each plug-in in the binary.

In one configuration, which provides such link time specificity, at link time a text file containing the plug-in list is consulted to optionally link in plug-in objects Once a plug-in is linked in, the plug-in's entry point replaces the plug-in entry stub. In such a configuration, plug-ins that are not specified just fail when called through their entry points (which go to the stub), whereas plug-ins that are linked in are able to proceed. Such a configuration allows the body of the code to run and execute without a-priori knowledge of which plug-ins will be linked in to form the resultant client image or product profile.

Configurations which offer link time specificity also facilitate linking in a ‘unit-test’ or internal tracking plug-in to the CHECKED (or DEBUG) version of the client to allow the client to do richer verification and validation during the test phase of the product.

As mentioned above, the plug-in system 126 allows a specified or particular combination of available plug-ins to be selected to create a desired product profile. Further, the plug-in system allows newly written or otherwise newly available plug-ins to be added to the data driven text file. The new plug-in(s), alone or in combination with existing plug-ins, can be linked in to create a new product profile. As mentioned above, if the new plug-in relies upon properties which are not already listed by the property system 124, those new properties and their associated property rules can be added to the property system as described above.

For instance, if a potential need is recognized for a client application product profile beyond what is currently available, the plug-in system 126, in combination with the event and property systems 122, 124, provides a generic way for additional functionality to be added in a generic or decoupled manner. Assume for instance, that a client product profile does not include a mechanism for locally generating letters and symbols corresponding to keystroke events. The plug-in system 126, in combination with the generically extensible core 120 and the event and property systems 122, 124 provide a generic way to expose keyboard events so that plug-ins can have access to the information if so desired. A local keyboard input plug-in can be written or obtained which processes keystroke events into locally generated user-perceptible symbols and letters. Rather than altering the core code to contain a specific link to tie keystroke events directly to the new local keyboard input plug-in, the present implementations provide a decoupled solution. A generic extension point to keyboard events can be added to the core's code. The new local keyboard input plug-in is loaded by the plug-in system 126 and subscribes to keystroke events via the event system's subscription mechanism 204. The core's keyboard extension point is tied to the event system's publication mechanism 202 and does not directly reference the new local keyboard input plug-in. The local keyboard input plug-in can also learn about other properties of the core from the property system 124. For example, the local keyboard plug-in can query a property to determine if certain keys should be handled on the server or not. The local keyboard input plug-in can act consistently with the behavior of the rest of the client in processing input intended for the server based upon the property. For instance, the local keyboard input plug-in could look at a property called, for instance, “RedirectWindowsKey” to see if the client is expecting to send the “Windows” key to the server or not and take actions to remain consistent with those expectations.

The local keyboard input plug-in is further enabled to coordinate with other components. For instance, the local keyboard input plug-in may want to know how a remote keystroke packet is handled by the core 120 so that when the remote packet is received, the local keyboard plug-in can take appropriate action such as removing its locally generated keystroke representation. In such a case the local keyboard input plug-in can listen to an event published when display updates come in from the server notifying the client of any ‘text’ drawn on the server side. Such functionality can be accomplished without being specifically tied to the core code by adding the local keyboard input to the data driven plug-in mechanism 212. Further, a new sub-set of plug-ins for achieving a specific new client product profile can be added to the reference table of the data driven plug-in mechanism 212. The new client product profile can then become functional by linking in the sub-set of plug-ins from the reference table.

The plug-in system 126 facilitates componentization at the binary level in that it allows for specified plug-ins 200 to be included at link time to achieve a particular client application product profile without altering the core's code. Such a system facilitates reliability of the client application in that, once the core's code is tested and validated, that code can be maintained for multiple different product profiles. For instance, the system runs the same code in the core from the thinnest to the richest product profiles by allowing additional features to be coupled to the core in a cleanly extensible way. Stated another way, the above described link time specificity, allows building a single-standalone EXE out of a very modular core. The single standalone EXE is beneficial in terms of easier deployment, serviceability and less versioning issues that would occur if each of the modules were treated as individual DLL's. The above described configuration further provides flexibility as to forming a system configuration. For example, in some instances as mentioned above, modules can be treated as DLLs, while in other instances linking can be utilized. For instance, treating modules as DLLs can be beneficial where the number of modules is relatively low. When the number of modules and hence DLLs becomes relatively high, for instance ten or more, associated installing, servicing and versioning of individual DLLs may become burdensome. In such instances, link time specificity can be utilized rather than DLLs.

The implementations described above and below are described in the context of a computing environment as commonly encountered at the present point in time. Various examples can be implemented by computer-executable instructions or code means, such as program modules, that are executed by a computer, such as a personal computer or PC. Generally, program modules include routines, programs, objects, components, data structures and the like that perform particular tasks or implement particular abstract data types.

Various examples may be implemented in computer system configurations other than a PC. For example, various implementations may be realized in hand-held devices, multi-processor systems, microprocessor-based or programmable consumer electronics, network PCs, minicomputers, mainframe computers, cell phones and the like. Further, as technology continues to evolve, various implementations may be realized on yet to be identified classes of devices. For example, as the cost of a unit of processing power continues to drop and wireless technologies expand, computing devices resembling today's cell phones may perform the functionalities of today's PC, video camera, cell phone, and more in a single mobile device. This single device may in one scenario act as a server and in another scenario act as a client. This is but one of many existing and developing examples for the described implementations.

The terms server and client as used herein do not connotate any relative capabilities of the two devices. The client may have more, less, or equal processing capabilities than the server. Rather, in this document, the names server and client describe the relative relationship of the two components. For example, a computing experience of a first or server device is remoted to a second or client device.

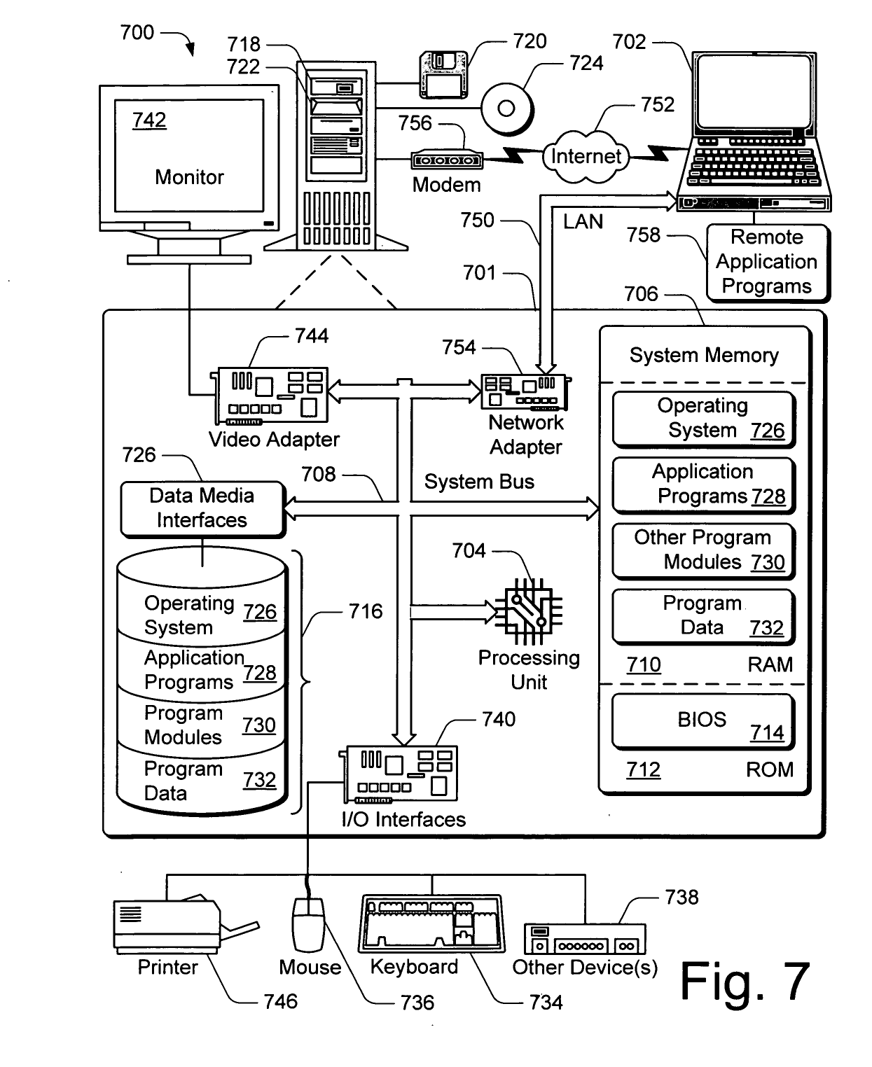

Although the various implementations may be incorporated into many types of operating environments as suggested above, a description of but one exemplary environment appears in FIG. 7 in the context of an exemplary general-purpose computing device and which is described in more detail later in this document under the heading “Exemplary Computing System”.

Exemplary Processes

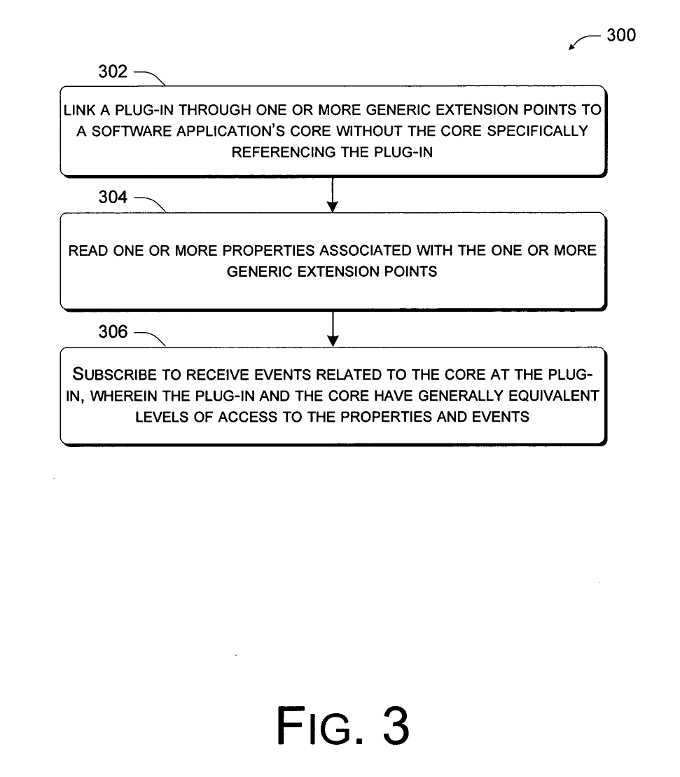

FIG. 3 illustrates an exemplary process 300 for extending a client application in a generic manner. The order in which the process is described is not intended to be construed as a limitation, and any number of the described process blocks can be combined in any order to implement the process. Furthermore, the process can be implemented in any suitable hardware, software, firmware, or combination thereof.

At block 302, the process links a plug-in through one or more generic extension points to a software application's core without the core specifically referencing the plug-in. The generic extension points provide access points related to core properties which may be of interest to the plug-in. In but one implementation, plug-ins are linked by a plug-in service which facilitates interactions between the plug-in and the core and other services available to the plug-in relative to the core.

At block 304, the process reads one or more properties associated with the one or more generic extension points. In some instances, the plug-in reads the properties by obtaining the properties from a location other than the generic extension points. For example, the plug-in may obtain the properties from a centralized location which serves to decouple the properties from their associated generic extension points. For instance, in but one system implementation upon which block 304 can be achieved, a property service lists the properties in a centralized manner for access by the plug-in.

At block 306 the process subscribes to receive events related to the core at the plug-in, wherein the plug-in and the core have generally equivalent levels of access to the properties and events. The plug-in can receive the events without being directly referenced by the core. For instance, the events can be handled by a service which decouples a source of the event from a consumer of the event. So for instance, in one implementation, the service gathers the events from extension points of the core and generically publishes the events to any interested plug-in. The service can be further organized such that the plug-in can subscribe to specific types of events. The service then automatically publishes such events to the plug-in as the events occur. In at least some exemplary processes, the event is actually passed to the plug-in such that the plug-in can modify and/or consume the event.

The above mentioned process blocks, individually and/or collectively, allow plug-ins and/or sets of plug-ins to be added on top of the core to augment the core's functionality such that a specific client application product profile can be achieved. The plug-ins or sets of plug-ins can be added on top of the core without altering the core, such as by referencing specific plug-ins in the core's code. So for instance, the process allows the core to operate by itself to achieve a first basic client application product profile. The same core can operate with a first set of plug-ins to achieve a second client application product profile, and with a second set of plug-ins to achieve a third client application product profile. The core does not need to specifically reference specific plug-ins. Further, the plug-ins receive a similar or identical level of services available to the core, such as in relation to events and properties. The described process blocks can further facilitate interoperability between the core and the plug-ins. For instance, in one scenario the core and the plug-ins may be produced by the same entity. In another scenario, the core and some plug-ins may be produced by a first entity and other plug-ins may be produced by a second entity. In still another scenario, the core may be produced by one entity, while the plug-ins are produced by one or more other different entities. The skilled artisan should recognize that the generic extensibility offered by the process described above facilitates component interoperability when compare to existing processes.

Exemplary Client Application

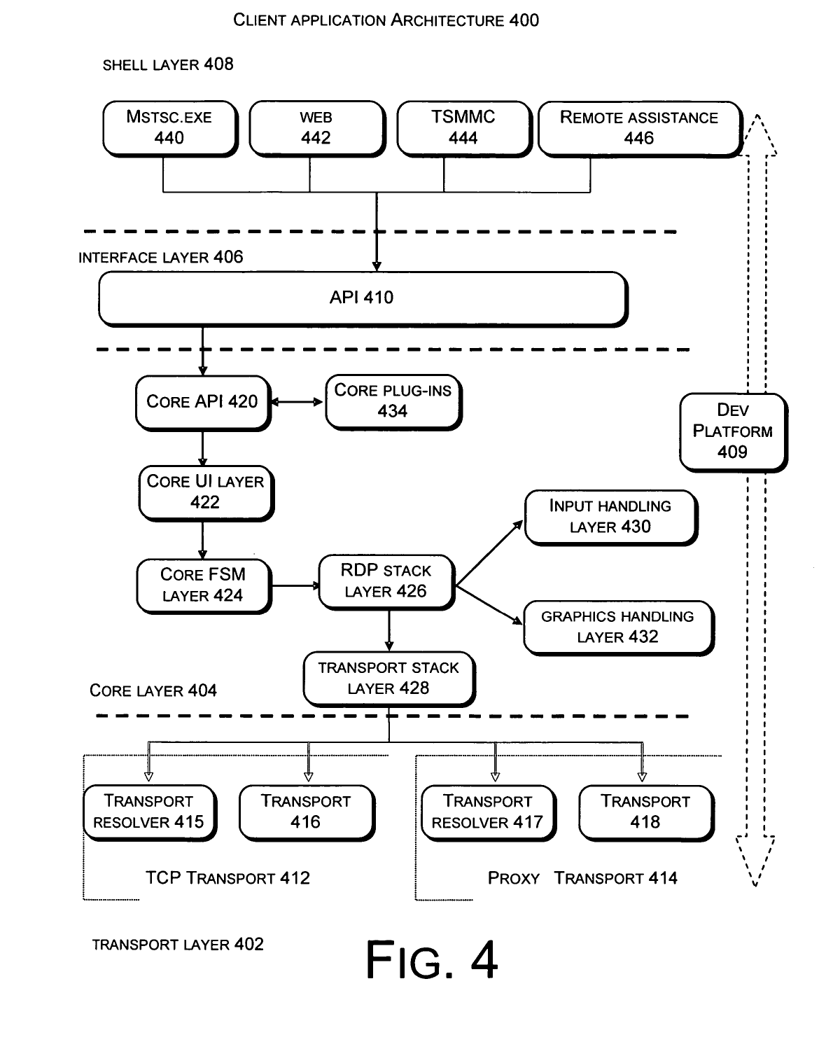

For purposes of explanation, a description is provided below in relation to but one exemplary generically extensible client architecture consistent with the concepts described above and below. In this instance, the exemplary architecture is described in relation to remote terminal session client application architecture 400 shown in FIG. 4. In this instance, the remote terminal session client application is described in the context of a remote desktop protocol (RDP) client which comprises a portion of a Terminal Services™ brand remote terminal session product offered by Microsoft Corp. Examples of other exemplary architectures and client applications should be recognized by the skilled artisan.

In this instance, client application architecture 400 is logically separated into several functional layers composed of decoupled objects that interact through a common set of core services. Individual layers are componentized and in many cases pluggable to allow maximum customizability and extensibility. The lifetime for the individual components is managed in a unified way throughout the client. In general, cross-layer dependencies are kept to a minimum and are defined through clean and explicit interfaces.

The functional layers in the exemplary client application architecture 400 are a transport layer 402, a core layer 404, an interface layer 406, and a shell layer 408. These layers are illustrated in relation to an ascending developmental platform 409 from the transport layer 402 to the shell layer 408.

The transport layer 402 is a set of plug-ins which can work alone or in cooperation with each other to provide a rich connection functionality. The transport layer manages resolving a connection name such as “HTTP://myserver or TCP://myserver or PROXY:://myproxy/proxyparms&server=foo&proxymode=bar, among others.

The transport layer 402 utilizes one or more plug-ins to make individual connections. In at least some configurations, the transport layer plug-ins can cooperate together in a sequence of attempting to connect through various modes and falling back and trying other plug-ins as attempts fail. This can, for example, be used to implement a scheme where a transport layer plug-in can try to connect using a default protocol such as transmission control protocol (TCP) and if that attempt fails, the transport layer plug-in can override the error and then attempt to connect with a different format or techniques such as through a proxy plug-in. Such an example is described in more detail below, Such flexibility can contribute to an enhanced user experience since from the perspective of the user, the system ‘seamlessly’ works, though in the background, the transport layer may be trying the various modes to enable a successful connection.

The above described process of chaining together transport plug-ins and trying different options can be driven by a new transport plug-in that acts to aggregate or try existing transports in new sequences. The system further allows such a new transport plug-in to be created by the same party which supplies the client application's core code or a second different party.

Transport layer 402 includes a TCP transport functionality 412, and a proxy transport 414. The TCP transport 412 includes a transport resolver 415 for resolving DNS names to an endpoint address, and a transport 416 for actually making the connection and providing an ITSTransport abstraction. Similarly, Proxy transport 414 includes a transport resolver 417 for resolving proxy host addresses to an endpoint and selecting an actual transport plugin, and a transport 418 for providing connectivity through a proxy server.

The core layer 404 achieves a basic functionality of the client and provides protocol related functionality. The core layer tends to be the most complex of all functional layers. To reduce the complexity, this layer has been well componentized. The componentization of the core layer is described in more detail below under the sub-heading “core layer components”.

Interface layer 406 sits on top of core layer 404 and provides secure interfaces to enable different type of shells to be utilized with the client. In this instance, Interface layer 406 is manifest as an AcitveX interface layer, other configurations should be recognized by the skilled artisan. Interface layer 406 provides an API 410 configured to facilitate communication between the core layer 404 and the shell layer 408. In some instance, the interfaces are also scriptable to allow quick shell development by other parties.

Shell layer 408 utilizes the ActiveX interfaces to enable diverse user scenarios using remote desktop. For instance, one implementation provides a rich windows application, such as mstsc.exe 440, a web based shell 442 such as tsweb, and a MMC snapin, such as tsmmc.msc 444. Additionally remote assistance 446 also utilizes the ActiveX layer.

In this implementation, shell layer 408 utilizes the interfaces supplied by Interface layer 406 to enable diverse user scenarios using a remote terminal session functionality.

The layers mentioned above utilize or sit upon the common services provided by DevPlatform (e.g. threading, eventing and notification system, property sets, object management and debug services). More details regarding the DevPlatform services are described below.

Core Layer Components

In this implementation, the client core is composed of a core API 420, a core user-interface (UI) layer 422, a core finite state machine (FSM) layer 424, a remote desktop protocol (RDP) stack layer 426, a transport stack layer 428, an input handling layer 430, a graphics handling layer 432, and core plug-ins 434.

The core API 420 serves to hide the core's internal implementation, such as a threading model and objects. The core API 420 also provides a simple interface to interface layer 406.

The core UI layer 422 manages the parent display window of a session. It manages the scrollbars and maintains a window that is a parent to the output window (OP). It also handles various dialogs (e.g. auto-reconnect) and the BBar.

The Core FSM layer 424 implements the finite state machine that leads the client through various RDP protocol stages. Core FSM layer 424 is the primary driver of other components during connect and disconnect phases.

RDP stack layer 426 provides a pluggable filter based chain for RDP data processing. RDP Stack Layer 426 is organized as a chain of pluggable filters. The data from the network enters the bottom filter and flows to the top. Data to the server enters the top and flows down in the chain. Each filter can look at the data and can decide if any action is needed (e.g. compression, encryption etc). This model makes it very convenient to add any extensions to RDP data processing.

The transport stack layer 428 manages the interaction of client core layer 404 with transport plug-ins. Transport stack layer 428 drives the name resolution, re-targeting across transport plug-ins and connect/disconnect at transport level.

The input handling layer 430 is responsible for sending user input, such as keyboard and mouse, to the server. The input handling layer is also responsible to maintain synchronization of client and server keyboard state.

The graphics handling layer 432 is responsible for decoding and drawing the graphics data sent by server.

The core plug-ins 434 are instantiated and initialized by core API 420. The core plug-ins 434 can receive notifications about various events in the client core layer 404, such as display update, auto-reconnect, start, among others, through event dispatch infrastructure, such as may be provided by dev-platform, among others. Additionally, core plug-ins 434 also use various services provided by core API 420, such as threading and virtual channels etc.

In summary, the core layers 420-434 serve as an extension point. For instance, the core layers can utilize the mechanisms mentioned in relation to the event system, property system and plug-in system to communicate with other core layers and thus act as extension points for plug-ins to hook-in, extend, or replace the core functionality. The core layers further serve as extension points by communicating through clean, well-defined and generic interfaces e.g. the different layers of the RDP stack are very decoupled and communicate up and down the stack by referring to a generic protocol filter (ITSProtocolHandler) rather than any specific protocol layer. For example, a plug-in can insert itself in the protocol stack layer to add a new security or compression type to the stack.

Client Connection Sequence

A sequence of how a connection request flows through the client core is described below. The core UI layer 422 is asked to proceed with the connection once initialization is successfully finished. The core UI layer sends the request down to core FSM layer 424 after the core UI layer satisfies its pre-connect checks. The core FSM layer 424, marshals the connect call through an appropriate processing thread. Core FSM 424 then creates and initializes the RDP connection stack if not already accomplished.

The RDP stack layer 426 creates the appropriate protocol filters and calls to connect on the top most filter in the stack. The connect call is chained down in the protocol stack until the call reaches the transport plug-ins at the bottom of the protocol filter stack. At that point the transport plug-ins take over and establish the physical connection with the server. The transport stack layer 428 fires a notification with the result of connection attempt.

Core Services

The described architecture provides a de-coupled design with objects that live in a system of related components. The components should be factored into groups of related objects and have minimal or no intermingling; cross component communication or rather cross component-group communication should happen through well defined interfaces. In one such implementation, cross component-group communication is provided through the event system which provides an automatic extension point and loose coupling.

Core services is about solving that problem by providing rich, unified models for handling properties, events and lifetime management. These services naturally extend to the plug-in model or plug-in system and are a key part of making the described core more extensible.

What follows is a detailed description of the various services in the described remote desktop protocol client. These services define high level building blocks for the rest of the architecture.

Plug-Ins/Components

In at least some implementations, plug-ins use basic COM interfaces and standard COM rules. For instance, life management can be achieved through a lifetime management interface such as ‘IUnknown’. Discovery of other interfaces can be achieved through an interface discovery interface such as ‘QueryInterface’. Object system characteristics can be derived from an object system interface such as ‘ITsComponent’. The plug-ins can implement any layer specific or component specific interfaces such that communications to the objects go through well defined interfaces. External plug-ins, such as inproc DLLS, are instantiated through a creation interface such as /CoCreatelnstance’. Internal plug-ins such as compiled-in plug-ins in LIB form, statically register themselves through a plug-in ID, such as ‘PLUGUID (Plug-in-Guid)’. The plug-ins may also utilize a debugging functionality such as ITsDebugComponent in checked builds. Simple header files are utilized to define the interfaces. A common interface such as ‘ITsComponent’ can provide a common interface for all plug-ins. The following method provides one such instance.

```
//
// Common interface for generic operations that all
// components must implement
//
Interface ITsComponent
{
  //
  // Request for the object to initialize itself.
  // Note: Objects should be able to reinitialize
  //  after a Terminate call
  // Params:
  // IN pCoreServices - access to client OM
  //
HRESULT Initialize(
  IN IRdpCoreServices* pCoreServices
  );
  //
  // Instruct the object to run itself down and release
  // system resources etc.
  //
  HRESULT Terminate( );
}
```

Reserved Range for Internal GUIDs

A range of GUIDs is reserved for internal GUIDs. Such a configuration allows the system to optimize QI calls and component create calls. A file such as file ‘tsguid.h’ is provided that can be checked out to reserve or allocate GUIDs to components or interfaces.

Plug-In Instantiation

Plug-ins serve at least two functions. First, plug-ins allow runtime (post-compile) extensibility by loading external modules into the client's address space. Second, plug-ins allow compile-time customization by reconfiguring which components/plug-ins are included in the client with only link time changes.

Plug-ins are referred to by unique PLUGUID's. A PLUGUID is a GUID that can be mapped to an internal component instead of an external DLL. PLUGUIDS should, where possible, be allocated from the reserved range.

Plug-ins are loaded by calling a creation component such as by using a method call to the IRdpCoreServices::CreateComponent(IN PLUGUID plguid, IN IID iid, OUT PPVOID ppInterface). Internally this call checks if the GUID specified maps to one of the internal GUIDs registered in an internal file such as the tscomps.h file. The following method provides one such instance.

```
  Tscomps.h:
  //
  // Sample section of registered GUIDS
  //
  // Maps GUID to implementation classes
  BEGIN_REGISTERED_COMPONENTS;
  TS_REGISTER_COMPONENT(PLUGUID_VIEWER,
CRdpViewer)
  TS_REGISTER_COMPONENT(PLUGUID_TCP_TRANSPORT,
CTcpTransport)
  TS_REGISTER_COMPONENT(
  {7272b107-c627-40dc-bb13-57da13c395f7},
  CMultimediaPlug-in))
  END_REGISTERED_COMPONENTS;
```

The component loader's (IRdpCoreServices::CreateComponent) search order is:
1) Search through internally registered components;

2) Try to CoCreateInstance the component to bring in external DLLs. This is optional functionality that can be compiled out. The following method provides one such instance.

```
//Sample of loading a viewer plug-in that is an internal
//plug-in
IRdpViewer* pViewer = NULL;
hr = pCoreServices->CreateComponent(
  PLGUID_VIEWER,  //component id
  IID_IRdpViewer, //requested interface
  &pViewer  //returned pointer
  );
```

Loading Plug-Ins

Some implementations support two types of plug-ins. For instance, the implementations can support general plug-ins that just want to live in the client's process and bind to the object model and can support specific plug-ins such as protocol filters, transports, protocol handlers etc. A base plug-in ‘loading’ infrastructure is one described in this section. Specific instances are described in more detail below.

Property System or Property Services

Properties are the various pieces of state that live in the system, these can be things like initialization state—e.g. Server Name or runtime state such as a Full Screen Boolean that indicates if the system is at full screen or not. A client such as an RDP client has hundreds of properties controlling everything from the color depth to connect at to various cache sizes. Plug-ins can and do have their own property sets e.g. the device redirection component has a set of properties indicating which devices are enabled.

Property services provides at least one or more of runtime storage of properties and runtime accessors (by name lookup rather than per-property get and set operations). Property services provides common validation services and data-driven initialization and default validation. So for instance, a new property can be added to the system simply by adding one line to a data table. Property services provides grouping of properties into a tree of property sets for related properties. Property services also provides fast, thread safe access to properties with reader/writer locks. The property services provides linkage to the event system to allow any plug-in to register itself for change notifications on individual properties or on property-sets. For instance, a plug-in registers “tell me when the Full Screen state changes” or “tell me when any redirection property changes”.

The property services also provides a change locking for properties and property-sets. For instance, a plug-in can simply say “no more changes allowed to caching properties now that we are connected”. Property services makes it simple to catch change attempts at debug time and record stack traces.

Property services facilitates finding scriptable get/put accessors for properties, as well as implementation of common OLE persistence models such as IPropertyBag.

Property services enables a light-weight system configuration. For instance, in some implementations, properties unchanged from their defaults will occupy no working-set, everything will remain in static const data. This is significant as a typical ‘mstsc’ connection only changes about 10 out of 300 of the default properties.

Property services enables a dynamic configuration. For instance, plug-ins can introduce new properties into the system at runtime and get all the benefits mentioned above. Plug-ins also now have access to all the properties in the system.

Design Details

In some implementations, properties are initialized from static tables that are specified in the source code image and remain read-only in memory in the binary. An example of such a static table is a const table, where ‘const’ is the a C language specifier for marking a data structure as unchangeable, thus allowing the compiler/linker to optimize the data structure's placement in memory. In a given scenario only properties that are changed from their defaults will actually get an allocation for a dynamic node. Some implementations may allow multiple properties to be grouped together as a logical group or set of related properties (propsets). Such a configuration can allow operations to be applied to an entire set of properties. Propsets may be organized in a tree structure, an example of which is described below.

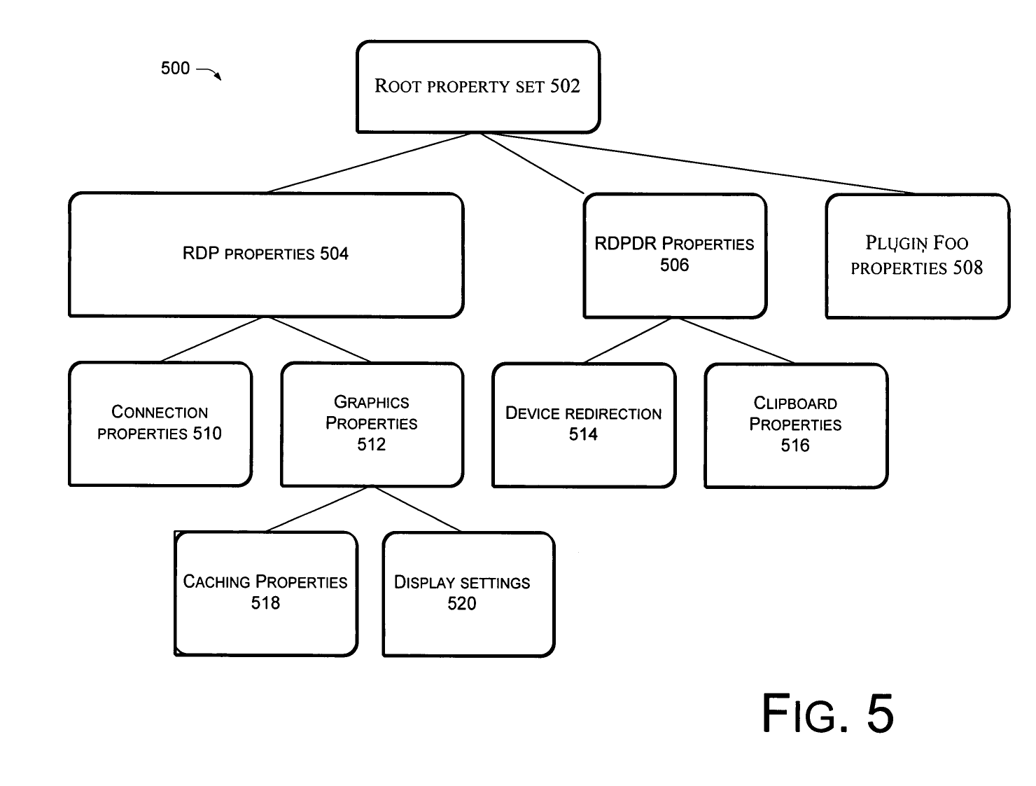

FIG. 5 illustrates an exemplary property set tree 500 which can be enabled by various system structures such as the one evidenced in FIG. 4 to enable various actions. For instance, the system may allow a plug-in to ‘lock for write’ any properties under the ‘RDP Properties node’. In another example, the system allows a plug-in to receive notifications whenever any property under the ‘RDPDR Properties node’ changes. The property set tree 500 (propset tree) also allows new propset nodes to be inserted at runtime so plug-ins to the system can use property services.

The property set tree 500 includes a root property set 502, RDP properties 504, RDPDR properties 506, Plug-in FOO properties 508, connection properties 510, graphics properties 512, device redirection 514, clipboard properties 516, caching properties 518, and display settings 520. The root property set 502 is a conceptual container for all the properties. The RDP properties 504 are properties related to the connection. The RDPDR 506 are properties of a device redirection plug-in. Plug-in FOO properties 508 are properties related to a plugin foo. Connection properties 510 are properties of the transport making the connection, and include for instance, port number and server name, among others. Graphics properties 512 are properties related to graphics decoding/rendering. Device redirection 514 is properties related to the device redirection plugins. Clipboard properties 516 are properties for the clipboard component such as “redirectclipboard”. Caching properties 518 are properties related to caching and includes for instance, cache size. Display settings 520 are properties for display settings and include for instance, color depth, use shadow bitmap, among others.

Note that the propset structure does not imply a search through the tree to find properties. The property sets themselves are the units where the actual properties live, probably organized in a hash table. Locking for thread safe access is also done at the propset level allowing for finer grained locking without the cost of a lock per property.

The following implementation describes but one example of a property metainfo initialization table for the property sets under ‘RDP Properties’.

```
  Sample property set initialization (preliminary):
  const defaultProperties [ ] =
  {
  //Property name, Owning propset, type, valid_min, max,
default, event list
  {“ServerName”,”ConSettings”,PROPTYPE_STRING,0,260,”
”,NULL},
  {“PortNumber”,”ConSettings”,PROPTYPE_INT,0, 65535,33
89,NULL},
  {“BmpCacheSize”,”CacheSettings”,PROPTYPE_INT,0,10,8,
NULL},
  }
```

Assume for purposes of explanation that the desired tree grouping for property sets is specified by some other data table. At runtime a propset factory initializes the propset tree by walking over the const data and populates the propset nodes with information from the static tables.

In some instances, a key size optimization is obtained in that property nodes which are unchanged from their defaults simply act as a reference to the const data.

The following implementation provides but one example of an interface for the property sets.

interface IPropertySet
{

```
  //
  // put_* methods for different types
  //
  HRESULT put_PropertyInt(
  LPTSTR szPropName,
  INT value
  );
HRESULT put_PropertyString(
  LPTSTR szPropName,
  LPTSTR szValue,
  INT len
  );
//etc for all needed types
//
// get_* methods for different types
//
HRESULT get_PropertyInt(
  LPTSTR szPropName,
  INT* pValue);
HRESULT get_PropertyString(
  LPTSTR szPropName,
  LPTSTR szValue,
  INT len);
//
// Threadsafe access to the property set
//
HRESULT EnterReadLock( );
HRESULT LeaveReadLock( );
HRESULT EnterWriteLock( );
HRESULT LeaveWriteLock( );
//
// Locked for write
//
BOOL IsPropSetWritable( );
HRESULT LockPropSetForWrite(
  BOOL fLockChildren,
  BOOL fLockSet);
//
// Event notifications will be dealt with in a later
```

section

```
//
HRESULT RegisterPropertyChangeNotification(
  LPTSTR szPropName,
  ICoreEventSource* pEvSource
  );
// Set wide notification
HRESULT RegisterPropertySetChangeNotification(
  BOOL fRegisterForChildren
  ICoreEventSource* pEvSource
  );
//
// Navigation functions
//
HRESULT  GetParentSet(IPropertySet** ppPropSet);
HRESULT GetFirstChildSet(IPropertySet** ppChild);
HRESULT GetNext(IPropertySet*  pCur,
```

IPropertySet** ppNext);

HRESULT GetPrev(IPropertySet* pCur,

IPropertySet** ppNext);

}

This interface is an example of a configuration which can achieve the design goals listed above. For example a property ‘Put’ function will automatically perform the appropriate validation using values from the metainfo tables. In some instances validation can involve calling an ‘exception’ validation function to perform any validation that can't be expressed in the tables. Such an example might be ColorDepth which needs to be validated for a set of values.

In at least some configurations, property services exposes an interface, such as IPropertyServices interface, which allows for obtaining the various IPropertySet interfaces. A separate factory may be utilized to instantiate propsets and introduce new propsets into the system. For example, propset instantiation and introduction can be accomplished using constant data tables as initialization and/or through programmatic calls at runtime. An example of but one such interface is described below.

```
interface IPropertyServices
{
  HRESULT  GetRootPropSet(IPropertySet**
ppRootPropSet);
  HRESULT GetPropSetByName(
    LPTSTR szPropSetName,
    IPropertySet** ppPropSet
  );
}
```

Event Model or Event System

The event or eventing model in a remote desktop (RDP) client application is configured to provide a unified eventing model or system. The event system enables a publish-subscribe model where the event model acts as an intermediary between the source and the sink leading to a more decoupled design. The event model provides event notification chains so multiple components can ‘listen’ on one event. The event model allows any component to ‘eat’ (also known as consume or cancel) an event and therefore prevent the event from being propagated. For instance, a component could hook into keystrokes and decide that the component wants to process ‘ctrl-alt-pause’ at the client-side. The component could then eat that event and prevent it from going on to default processing. The event model allows automatic and transparent handling of cross-thread notifications (same model used to notify cross thread and within the same thread). The event model provides the option of disabling/enabling any events at runtime. For instance, the event system allows events to be stopped in relation to a specific component at a specific time. For instance, the event system can enforce a command such as “no more events sent to graphics component while the graphics component is shutting down”. The event model further facilitates ease of understanding an event status. For instance, can an event be fired to an outside component that could change the caller's state. Further, the event model offers the advantage of low overhead and ease of debugging. For instance, in relation to a debug build, the event model provides the ability to record stack traces for all event sources.

Event Model Usage

Core event services is accessible via the ITSCoreEvents interface, this interface allows components to register notification sources and bind sinks to those sources. Once a source has been registered it can be accessed via it's ITSCoreEventSource interface.

An example of the Core Events interface is provided below.

```
interface ITSCoreEvents
{
  //
    // Allocate a new event ID
    //
    virtual HRESULT
    AllocateEventID(
      OUT TS_EVENT_ID* uiEventId
      ) = 0;
    //
    // Free a previously allocated event ID
    //
    virtual HRESULT
    FreeEventID(
      IN TS_EVENT_ID uiEventId
      ) = 0;
    //
    // Register an event by ID
    //
    virtual HRESULT
    RegisterNotificationSource(
      IN  TS_EVENT_ID
      uiEventSourceId,  OPTIONAL
      OUT  ITSCoreEventSource**
      ppEvSource
      ) = 0;
    //
    // Register an event by name
    //
    virtual HRESULT
    RegisterNotificationSource(
      IN LPTSTR szEventName,
      OPTIONAL  OUT
      ITSCoreEventSource**
      pEvSource
      ) = 0;
    //
    // Register a nameless event
    //
    virtual HRESULT
    RegisterNotificationSource(
      OUT  ITSCoreEventSource**
      ppEvSource
      ) = 0;
    //
    // Bind a notification sink
    //
    virtual HRESULT
    BindNotificationSink(
      IN TS_EVENT_ID uiEventId,
      IN  ITSAsyncCallback*
      pNotification
      ) = 0;
    //
    // Bind the sink by name
    //
    virtual HRESULT
    BindNotificationSink(
      IN LPTSTR szEventName,
      IN  ITSAsyncCallback*
      pNotification
      ) = 0;
    //
    // Remove a notification sink
    //
    virtual HRESULT
    RemoveNotificationSink(
    IN TS_EVENT_ID uiEventId,
      IN  ITSAsyncCallback*
      pNotification
      ) = 0;
};
```

A beneficial way to illustrate the event model is with examples of what typical usage might be like. Several examples are described below.

Publishing an Event

Components can publish event sources either by numeric ID or by name (useful for plug-ins that want to introduce dynamic events into the system), or by using a nameless event. Publishing an event simply registers it with the event system and allows sinks to bind to it.

```
//Example of publishing some connection events
//By ID
ITSCoreEventSource* pEvSrc;
CoreEvents( )->RegisterNotificationSource(
  EV_NETWORK_CONNECTED,
  &pEvSrc);
//By Name
CoreEvents( )->RegisterNotificationSource(
  “NetworkConnected”,
  &pEvSrc);
//Nameless
CoreEvents( )->RegisterNotificationSource(
  &pEvSrc);
```

Details relating to the returned CoreEventSource object are provided below. The CoreEventSource object allows further manipulation of the event source for example to enable/disable it and also to actually fire synchronous or async notifications.

Subscribing to an Event

Sink components subscribe to events that were previously registered. The following method provides one such instance.

```
CoreEvents.BindNotificationSink(
  EV_NETWORK_CONNECTED,
  EVHANDLER_FN(CMyComponent,
  OnNetworkConnected)
  );
```

The event system takes care of correctly routing events, for example if the source and the sink are on the same thread a direct call will be made, otherwise the call will be marshaled to the other thread using either blocking (SendMessage like) or async semantics (PostMessage).

The CoreEventSource Interface

The following method provides one such instance.

```
Interface ICoreEventSource
{
  //
    // Return the event ID for this source
    //
  HRESULT
  GetEventID(
    OUT TS_EVENT_ID* uiEventId
    );
  //
  // Fire the event synchronously to all bound listeners
  //
  HRESULT
  FireSyncNotification(
    IN DWORD dwEventOptions,
    OUT DWORD* pdwResultFlags
    );
  //
  // Fire the event asynchronously to all bound
    listeners
  //
  HRESULT
  FireASyncNotification(
    IN DWORD dwEventOptions,
    OUT DWORD* pdwResultFlags
    );
}
```

Firing an Event

The following method provides one such instance of an event firing.

```
// pInterestingEventSource obtained when event was
    registeredpInterestingEventSource-
      >FireSyncNotification(
    0,
    NULL
    );
```

The event system will walk the appropriate event chains and notify components (some could live on other threads). As this proceeds the CoreEventStatus object is updated by the event handlers. For example an event handler could cancel the event from proceeding on to the next caller.

Events by default pass around a LONG_PTR parameter for user use. For extra flexibility the CoreEvent can also contain a variant type parameter with any additional information that needs to be passed.

Receiving an Event

In order to receive an event a class member function should be registered as a ‘Sink’ for an event.

The following example illustrates such a process.

```
class CMyExampleClass
{
public:
    //
    //
    //
    VOID Initialize( );
    //
    // The event sink callback
    //
    VOID OnMyInterestingEventSink(
        LPVOID param,
        ITSEvent* pEvent);
    //
    // Macro needed to expose members as event sink
        // callbacks
        //
    METHODASYNCCALLBACK(OnMyInterestingEventSink,
CMyExampleClass)
    };
    //
    // Illustrates how to bind to an event source
    //
    CMyExampleClass::Initialize( )
    {
        //
        // Bind ‘OnMyInterestingSink’ to
        // the event EV_INTERESTING_EVENT
        //
        CoreEvents( )->BindNotificationSink(
    EV_INTERESTING_EVENT,
    EVSINK_FN(OnMyInterestingSink)
                                        );
    }
    //
    // Receiving a basic event
    //
    VOID CMyExampleClass::OnMyInterestingEventSink (
            LPVOID param,
            ITSEvent* pEvent
            )
    {
      //Do some processing - param is passed in from the event
      //source and can be some event specific class
    }
```

Note the METHODASYNCCALLBACK and EVSINK_FN do work under the covers to seamlessly allow class methods to be exposed as global callbacks for parent classes of any type, there is no need for the class implementer to define static methods as callback entry points.

Advanced Features

In some system configurations event services allows a sink to choose it's placement in the notification chain. For example, in one scenario such a command may be exposed by passing a flag such as EV_MUST_BE_FIRST. In this case it is an error to register more than one sink as the first sink in the chain.

In another example, CoreEvents may expose APIs to allow enumerating through an event chain and inserting a sink before or after another sink. An example of such a scenario is provided below.

```
    //
    // To illustrate inserting an event sink for the connected
    // event before the sink for the multimedia component
    //
    CoreEventSink ceSink;
    CoreEvents.GetFirstSink(EV_NETWORK_CONNECTED,
&ceSink);
    while (ceSink.Valid( ) &&
        ceSink.ParentComponent( ) !=
COMPONENT_MULTIMEDIA) {
        ceSink = ceSink.GetNextSink( );
    }
    if (ceSink.Valid( )) {
      RegisterNotificationSync(ESINK_REG_BEFORE,
ceSink,
EVHANDLER_FN(CMyComponent,OnNetworkConnected));
}
```

Event services also makes it easy to fire events to the outside world by providing relays that bind core events to ActiveX events. To the user this is just visible as binding a new notification sink of type ‘ActiveX’. The following method provides one such instance.

```
//
// Firing an event that will also go to the outside world
//
//
// First the event is bound to the ActiveX
// event source.
//
CoreEvents.BindActiveXNotificationSink(
    EV_NETWORK_CONNECTED,
    pIDispatchEventSource,
    DISPID_EVENT_CONNECTED
    );
//
// The event is then fired in the normal way, several sinks
// will respond to it and they can be on different threads
// or the event can fire ActiveX (IDispatch) calls to the
// outside world.
//
```

Binding Vvents to Property Changes

The event system is integrated into the property system to allow components to easily receive notifications when their properties change. For example, to build the connection bar feature, the system should know when the connection bar is disabled:

```
CoreEventSource csPropertyEventSource;
pPropertySet->RegisterPropertyChangeNotification(
            “DisableConnectionBar”,
            &csPropertyEventSource
            );
    //
    // The property is now bound to an event source, a default
    // convention is to create a named event with a name of form
// OnChange’PropertyName’. Sinks can then bind themselves as
    // follows
    //
    // csPropertyEventSource also exposes properties that allow
    // a user to query for the event source ID to optimize instead //
of using a named lookup.
    //
    CoreEvents.BindNotificationSink(
        “OnChangeDisableConnectionBar”,
        EVSINK_FN (OnChangeDisableConnectionBar)
        );
    VOID CConnectionBar::OnChangeDisableConnectionBar(
            LONG_PTR param,
            )
    {
      if (TRUE == (BOOL)param) {
        DisableConnectionBar( );
      }
      else {
        EnableConnectionBar( );
      }
    }
```

The example above illustrates the power of the event and property systems. In some configurations, this property notification system will also be exposed to the outside world to callers who implement IPropertyNotifySink.

Processing in a Message Sink

When an event sink fires, the receive-side of the call can gain access to that thread's event queue and perform queue-centric operations. For instance, the receive-side of the call may peek for any further events of arbitrary type in the queue, eat (remove) any events from the queue, and/or collapse all events in the queue. For example, the receiver-side may issue an atomic ‘remove all events of this type’ and ‘let me process the last one’ command.

Event handlers can also choose to eat events themselves or set some status to indicate how the event source should proceed. Such an example occurs with an event that fires the current keyboard message. Some UI component that provides a drop-down toolbar with connection status can choose to listen for these key events and on detecting a certain hotkey could choose to ‘eat’ a certain key. This can be accomplished by setting a status on the event as follows using the ITSEvent interface passed in to every event sink. The following method provides one such instance relating to handling of events.

```
        //
        // Receiving a more complex event
        //
        VOID CMyComponent::OnKeyStroke(
    LONG_PTR param,
                ITSEvent* pEvent
    )
    {
      CKeyStrokeEvent* pKeyEv = (CKeyStrokeEvent*)param;
      BOOL fKeyDown = pKeyEv->GetBoolParam( );
      if (pKeyEv->Vk( ) == VK_SOMEKEY && fKeyDown) {
        // Do some processing and stop the rest
        pEvent ->CancelEvent( );
      }
    }
    interface ITSEvent
    {
      //
      // Access the event queue for this thread
      // details of ITSEventQueue TBD
      //
      HRESULT  GetEventQueue(ITSEventQueue**
ppEvQueue);
      //
      // Cancel the event, i.e. do not process it further
      // and return a status to the source
      //
      HRESULT CancelEvent( );
      //
      // Indicate a return code to the caller
      // only applies to Synchronously fired events
      //
      HRESULT SetReturnCode(HRESULT hretCode);
    };
```

Communications Plug-In Infrastructure

The communications layer provides an abstracted view of the low-level communications services the client uses to communicate with the remote endpoints in a remote terminal session scenario.

In this implementation, the communications layer has the following attributes:
Pluggable to allow replacement/extension of:
   Transports (e.g. TCP forward connect)
   Name resolution (e.g. simple DNS lookup or more complex SIP type negotiations that the RAP team will plug-in)
   Arbitrary pre-connection negotiations such as firewall traversal
   Protocol filters to allow layering of the protocol by appending extra headers (for example wrapping RDP in HTTP headers)
Provide a simple and clean interface with as very few functions to the upper layer components that makes no assumptions about possible implementations. For instance it is possible at one level to provide a file based transport that can be used to implement RDP recording and playback.
No special cases—the upper layers in the client object model operate in the same way regardless of which transport is in effect.
A ‘data-driven’ way to select transports through the concept of generic transport handlers.
Decoupling of name resolution (e.g. SIP lookup) from the actual transport portion (e.g. TCP data flow).
Support async name lookup and connection initiation
   Overview of the Communications Layer

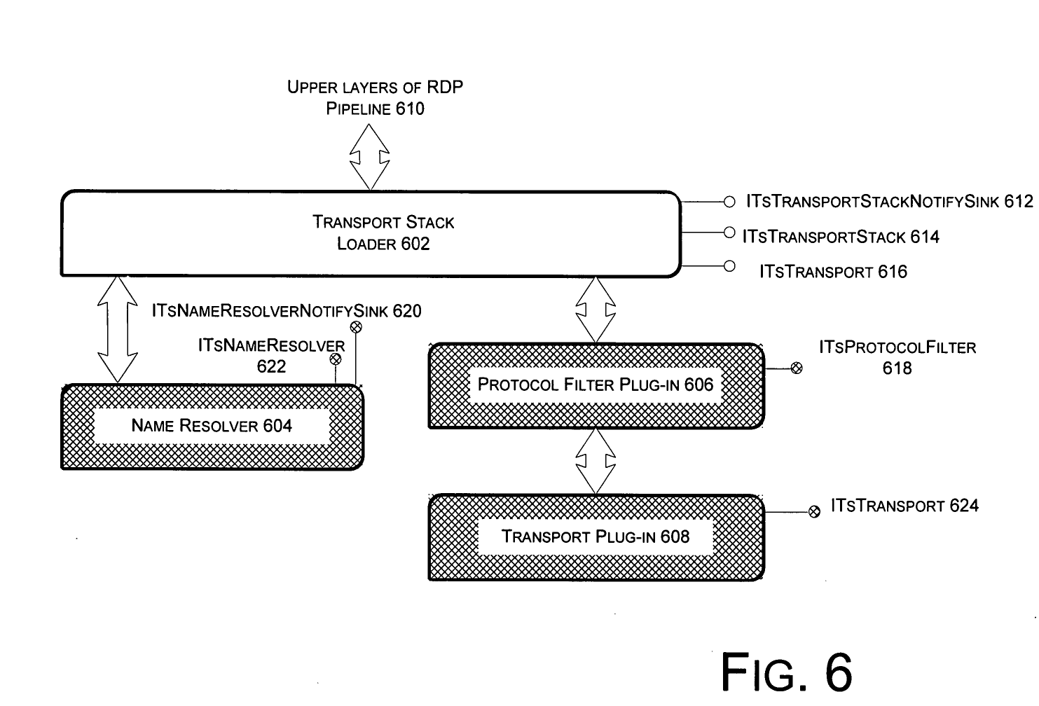

FIG. 6 illustrates a block diagram depicting the main components of the transport layer 402 and the COM interfaces they expose. Pluggable components are referenced with cross-hatching. FIG. 6 illustrates a transport stack loader 602, a name resolver 604, a protocol filter plug-in 606, and a transport plug-in 608. Transport stack loader 602 communicates with upper layers of the RDP pipeline as indicated generally at 610. FIG. 6 does not show that all components in the client expose the common ITsComponent interface that is used for initialization and safe rundown.

Transport Stack Loader

The transport stack loader 602 facilitates an ITsTransportStackNotifySink corn interface 612, a ITsTransportStack corn interface 614, and a ITsTransport 616 which is an integrated interface. The transport stack loader 602 presents the root interface to the transports through ITsTransportStack corn interface 614.

IsTransportStack interfaces 614 act as the root of the transport stack such as in the example provided below.

```
Interface ITsTransportStack
{
//
// Initialize the transport stack and bind to the
// event system to notify upper layers
//
HRESULT Initialize(
    IN ITsCoreEvents* pCoreEvents
        );
//
// Initiate the connection based on events fired through
// ITsCoreEvents
//
HRESULT StartConnect(
    IN LPTSTR szConnectionString
    );
//
// Trigger an orderly teardown of the connection or any
// lookup operations in progress
//
HRESULT Disconnect( );
//
// Get access to the top loaded transport
//
HRESULT GetTransport(
        OUT ITsTransport** ppiTsTransport
        );
};
```

ITsTransportStackNotifySink 612 provides notifications sink for the transport stack as in the example described below.

```
    // Internal interface for callbacks from the resolver
    // to the transport stack loader
    //
    Interface ITsTransportStackNotifySink
    {
    //
    // Notification that resolution has completed,
    // returns the requested transport GUID and a connection
    // blob to be passed to the transport
    //
    // pFilterInfo defines what protocol filters are to be inserted
    // into the RDP pipeline and is discussed in a later section
    //
    HRESULT OnNameResolved(
        IN DWORD dwResolveFlags,
        IN PLUGUID* pTransportGuid,
        IN FILTER_INFO* pFilterInfo,
        IN PBYTE pConnectionBlob,
        IN UINT cbConnectionBlobLen
        );
    //
    // ReTarget notification allows a resolver to ask the stack
    // loader to re-start the resolution phase with a different
connection
    // string
    //
    HRESULT ReTarget(
        IN LPTSTR szConnectionString
        );
    //
    // Async notifications
    //
    HRESULT OnError(
        IN PLUGUID* pComponentId,
        IN HRESULT hrErrorInfo
        );
    //
    // State notificcations
    //
    HRESULT OnConnected( );
    //
    // Notification that the transport has disconnected
    //
    HRESULT OnDisconnected(
        IN  TRANSPORT_DISCONNECT_REASON
discCode
        );
    HRESULT OnDataAvailable(
        IN PBYTE pData,
        IN UINT cbLen
        );
    //
    // Notification that the transport is ready to connect
    // an optional transport specific information block
    // is passed in. This for example can be used to let the
resolver
    // know what port a reverse-connect listener has accepted
    // a connection on.
    //
    HRESULT OnReadyConnect(
        IN PLUGUID TransportGuid,
        IN  OPTIONAL  PBYTE
pTransportReadyConnectInfo,
        IN OPTIONAL ULONG cbLen
        );
    };
```

Generic Connection Strings

When a connection is requested through ITsTransportStack::StartConnect the stack loader is passed a generic connection string of the form (<scheme>:<scheme-specific-portion>). Examples include, but are not limited to, “tcp:myserver.foo.com”, “http:myserver.bar.com”, and “sip:{123123-123123-123123-1213asd}”.

This connection string can be set directly as a property on the control by either the hosting shell application or by an internal plug-in that has full access to the client's object model. Also, the client will prepend the default prefix of “TCP:” to all legacy style connections to preserve compatibility with the existing IMsRdpClient::put_Server methods. Such schemes allow increased flexibility to the shell in selecting the appropriate connection method and also allows the default case to work with existing containers.

Mapping Protocol Schemes to a Protocol Specific Handler

The stack loader parses out the scheme portion; the scheme-specific portion is opaque data to be processed by the transport-specific components. A suitable name resolver component, such as is described above, is picked for the selected scheme from a mapping table in the client.

The scheme to transport handler table is built up from a hard-coded internal list (defined at compile time) and a dynamic portion that can be populated from exposed control APIs as well as a defined location in the registry.

The mapping allows the client to select an appropriate name resolver component for the protocol scheme which maps to a client PLUGUID. The transport stack loader then loads the appropriate protocol specific name resolver component.

Pluggable Name Resolver Component

The name resolver 604 the stack loader has instantiated is responsible for parsing the scheme-specific portion of the connection string and asynchronously doing any work needed to resolve that name to a connection endpoint. In the simple case of TCP forward connect (a.k.a. TCPF) this would require doing a DNS lookup and resolving to an IP address or a connected socket endpoint.

The name resolver 604 exposes a simple interface but can do arbitrarily complex work such as going through an entire SIP protocol sequence with a remote host to determine an alternate connection point.

The name resolver 604 also performs one other very important function which is to select an appropriate transport component for the connection e.g. it could select the TCP Forward connect transport component. Some name resolvers, such as the default DNS resolver, will simply return a hard-coded PLUGUID to the TCP Forward connect transport. More complex resolvers may go through an arbitrarily complex decision making process before selecting the transport to load.

Once the appropriate transport has been selected and the name resolved to an opaque connection block, the transport stack loader 602 is notified via an event sink and it can proceed to load the appropriate transport component and pass it the connection block. Illustrative examples of many different scenarios are provided in later sections.

ITsNameResolver

An example of ITsNameResolver 622 is described below.

```
    Interface ITsNameResolver
    {
    //
    // Resolver call
    // Note: The username/password are optionally passed in e.g.
and
    // may be used by the resolver to do things like gain proxy
access
    //
    HRESULT ResolveName(
        IN LPTSTR szConnectionString,
        IN ITsTransportStackNotifySink* piNotifySink
        IN OPTIONAL LPTSTR szUserName,
        IN OPTIONAL LPTSTR szPassword
        );
    //
    // Cancel the async operation in progress
    //
    HRESULT Cancel( );
    };
```

The callback mechanisms above are provided to make it simpler to write more complex resolvers that may need to go through lengthy protocol sequences, such as SIP, and therefore may not work under the context of a blocking ResolveName call. It is possible to write simple blocking resolvers that directly call the notify sink from within ITsNameResolver::ResolveName.

More complex resolvers can implement the optional ITsNameResolverNotifySink 620 interface to get notified if the transport failed to connect or otherwise disconnected. Such a configuration allows more complex scenarios where the resolver can attempt one type of connection, and on failure to connect re-try with an entirely different method. One such example is detailed below.

```
    Interface ITsNameResolverNotifySink
    {
    //
    // Notification that the transport has disconnected
    //
    HRESULT OnTransportDisconnected(
        IN PLUGUID TransportGuid,
        IN HRESULT hrTransError,
        OUT BOOL* pfErrorHandled = FALSE
        );
    //
    // Notification that the transport is ready to connect
    // an optional transport specific information block
    // is passed in. This for example can be used to let the
resolver
    // know what port a reverse-connect listener has accepted
    // a connection on.
    //
    HRESULT OnReadyConnect(
        IN PLUGUID TransportGuid,
        IN  OPTIONAL  PBYTE
pTransportReadyConnectInfo,
        IN OPTIONAL ULONG cbLen
        );
    //
    // Cancel the async operation in progress
    //
    HRESULT Cancel( );
    };
```

On handling the ITsNameResolver::OnTransportDisconnected method, the name resolver component can set the pfErrorHandled flag to TRUE to prevent the error notification from percolating higher up the stack. Such a configuration effectively allows name resolver component to override the transport error and attempt to reconnect using a different scheme.

Pluggable Transport Plug-Ins

Transport plug-ins 608 are where the transports are primarily implemented. The Transport plug-ins provide an endpoint to send and receive data from.

Once a name resolver 604 has mapped a connection string to a transport PLUGUID the transport stack loader 602 loads and instantiates the appropriate transport component handing it the opaque connection blob that the resolver generated.

An example opaque connection blob for the TCP transport could contain a union that allows connection options to be a SOCKET, IP address or a DNS name. In the case of the DNS name the transport would have responsibility to resolve the name itself for increased flexibility. In other configurations, the resolver may accomplish the DNS lookup.

An example of transport specific connection info: TCP transport is described below.

```
struct tagTCP_CONNECTION_INFO
{
  //flags that specify which of the union fields apply
  ULONG connectionType;
  // Union of different connection types
  Union {
  // An already connected socket identifier
  SOCKET_INFO hConnectedSocket;
  // An IP address
  TCHAR szIPAddress[MAX_IP_LEN];
  // A DNS name
  TCHAR szDNSName[MAX_DNS_LEN];
  } u;
};
```

Once a connection is initiated, the transport's ITsTransport interface 6218 is aggregated by the transport stack loader 602 and exposed to the upper levels in the client for use in sending and receiving data. For instance, the transport stack loader 602 does no data-copying and allows data to flow directly to the transport components without adding any overhead.

ITsTransport Interface

An example of ITsTransport Interface is described below.

```
    //Buffer handle definition - an opaque data type
    typedefULONG_PTR TS_BUFHND, *PTS_BUFHND;
    Interface ITsTransport
    {
    //
    // State management
    //
    //
    // Setup the transport and hand it the notification
    // interface it will use to notify the upper layers of
    // interesting events such as Connection completed,
    // disconnection and data available
    //
    HRESULT Initialize(
        IN ITsTransportStackNotifySink * pStackNotifySink
        );
    HRESULT Connect(
        IN PBYTE pbConnectionBlob,
        IN UINT cbLen
        );
    HRESULT Disconnect(
        );
    //
    // Send calls
    //
    HRESULT GetSendBuffer(
        IN UINT cbDataLength,
            OUT PBYTE* ppBuffer,
        OUT PTS_BUFHND pBufferHandle
        );
    HRESULT SendData(
        IN PBYTE pBuffer,
            IN UINT cbDataLength,
        IN TS_BUFHND bufHandle
        );
    //
    // Receive calls
    //
    HRESULT ReadData(
            IN PBYTE pBuffer,
        IN UINT cbLen
        );
    HRESULT IsDataAvailable( );
    //
    // Buffer management, allows controlling how much extra
space
    // is padded to buffer allocations to allow room for protocol
    // filters to append data to the prefix or suffix of the stream
    // e.g. an HTTP filter could reserve space to append
    // data to the stream
    //
    UINT GetPacketReservedPrefixSize( );
    VOID SetPacketReservedPrefixSize(UINT cbSize);
    UINT GetPacketReservedSuffixSize( );
    VOID SetPacketReservedSuffixSize(UINT cbSize);
    };
```

The GetSendBuffer/SendData model is used to make it easier to provide async write capabilities but a transport plug-in might choose to simply do synchronous writes.

Regarding the ITsTransport::Connect method, the opaque data blob passed to this method is transport specific. For instance, in the case of a TCPF plug-in it could be a union that contains either IP address or a connected socket handle. The only other component that has to know the structure of this blob is the related Name Resolver.

The transport stack receives notifications such as DataAvailable, Connected, and Disconnected through the ITsTransportStackNotifySink 612 and where appropriate forward these notifications on to other components in the client's object model using the event system.

Pluggable Protocol Filters

Pluggable protocol filters are components that can be dynamically inserted at various points in the RDP pipeline (including within the transport layer) to modify the protocol stream as it flows through or run an entire protocol sequence by intercepting received packets and sending reply packets down. This can be used to, for example, implement an HTTP filter that first negotiates with a web server.

A key point is that filters can be stacked. This is a key distinction between a filter and a transport. Transports have a programmatic input/output at the top layer whereas filters have programmatic inputs and outputs at both the top and the bottom.

This mechanism can be used to implement layered protocols by appending headers to the protocol (such as HTTP) or even to apply other transforms to the data stream such as providing custom bulk encryption by encrypting the entire data stream as it flows through the filter.

The client's object model (OM) provides a fully programmatic way to dynamically insert any protocol filter PLUGUID into various points in the RDP pipeline such as before-encryption, after-encryption, before-compression, after-compression, and before-transport. Name resolution components can make use of the client OM to dynamically insert filters or they can communicate back a list of filters and their desired insertion points back directly to the transport stack loader through the FILTER_INFO parameter of ITsTransportStackNotifySink::OnNameResolved.

ITsProtocolFilter Interface

Protocol filter plug-in 606 facilitates an ITsProtocolFilter interface 618. An example of Interface ITsProtocolFilter is described below.

```
    {
    //
    // Initialize the filter and pass it the next (lower) and prev
(higher)
    // filter in the RDP pipeline. This allows a filter to run a
protocol
    // sequence by ‘Sending’ data to the next lower filter
    //
    HRESULT Inititalize(
        IN ITsProtocolFilter* pNextFilter,
        IN ITsProtocolFilter* pPrevFilter
        );
    //
    // Query filter properties
    //
    HRESULT GetFilterPacketExtentsNeeded(
        OUT PUINT pcbPrefixNeeded,
        OUT PUINT pcbSuffixNeeded
        );
    //
    // Input data path (downstream calls)
    //
    HRESULT SendData(
      IN PBYTE pBuffer,
            IN UINT cbDataLength,
      IN TS_BUFHND bufHandle
      );
    //
    // Receive calls (upstream calls)
    // Params:
    // pBuffer - buffer to read into
    // cbLen - size of read buffer
    // pfFilterAteData - set to TRUE by the filter to indicate it
consumed
    //  all the data.
    //
    // Stateful filters can run a protocol sequence by ‘eating’ the
data they
    // receive and sending replies down to the next filter in the
pipeline.
    // in this case they should set pfFilterAteData to TRUE
    //
    HRESULT ReadData(
            IN PBYTE pBuffer,
      IN UINT cbLen,
      OUT BOOL* pfFilterAteData
      );
    HRESULT IsDataAvailable( );
    };
```

As explained above, a filter can run a protocol sequence by processing data it receives from the network on the ReadData call and ‘eating’ it by not passing it up the pipeline (by setting *pfFilterAteData to TRUE). The filter can then send replies to the packets it processed by simply writing to the pNextFilter's ITsProtocolFilter::SendData.

To explain a little about the FILTER_INFO structure, it defines a simple data-driven way for a name resolver to specify which filters it wants appended and at what points in the RDP pipeline.

Filter_Info

An example of but one process relating to filter information is provided below.

```
    Struct FILTER_INFO
    {
      DWORD dwFilterFlags; //specifies which filters should
be replaced
      PLUGUID PreEncryptionFilter;
      PLUGUID PreCompressionFilter;
      PLUGUID PreTransportFilter
    };
```

Prior to connection setup the client walks all the filters in the RDP pipeline and uses their ITsProtocolFilter::GetFilterPacketExtentsNeeded method to compute how much (if any) packet space should be reserved for the filters—this is information that the client then passes to the ITsTransport::SetPacketReservedxxxSize properties to cause the transports to pre-allocate enough data for the filters. This mechanism allows filters to operate in place on the data stream and therefore avoid unnecessary data copies.

It is the responsibility of the RDP pipeline to correctly bind filters together and connect their inputs to their outputs as needed.

Example Usage and Control/Data Flow

To better illustrate the transport plug-in model, several examples are described below and involve simple DNS lookup and TCP connections, reverse connections, SIP types (pre-connection negotiation), HTTPS (i.e. HTTP+SSL encryption) and hybrid scenarios (fallback from one method to another).

Simple DNS Lookup and TCP Connection

This scenario illustrates how the new pluggable transport model supports today's default case of a direct TCP connection to a server.

First, some user action leads to a programmatic call to the control's IMsRdpClient::Connect interface requesting a connection to “tcp:myserver.com”. This generalized connection string is manufactured by higher level components and the “tcp:” default is pre-pended to all connection strings that don't specify a connection prefix.

Second, the call is propagated down to the transport stack level where ITsTransportStack::StartConnect is called passing it the connection string

Third, the transport stack loader 602 parses out the scheme identifier “tcp” from the connection string and looks up the appropriate scheme specific handler or Name Resolution of “tcp” connections. This maps to a plugin GUID (PLUGUID).

Fourth, the transport stack loader loads the appropriate Name Resolver by PLUGUID—in most cases this will be a statically linked component so no external DLLs need to be referenced but the support will be there to load in-proc COM objects.

Fifth, the stack loader QueryInterfaces for the name resolver's ITsName Resolver and then calls it's ITsNameResolver::ResolveName method passing it a notification sink interface ITsTransportStackNotifySink 612.

Name Resolution: From this point control is handed to the Name Resolver Component 604.

Sixth, the name resolver 604 parses the scheme specific portion of the connection string “myserver.com” for validity and to determine what further action should be taken. In this case the action is to resolve the DNS name to an IP address and a connected socket endpoint.

Seventh, since the server name passed to it is valid the name resolver 604 starts an async DNS lookup and returns control to the transport stack loader 602 which in turn bubbles up the call stack that async name resolution has started successfully.

Eighth, when the DNS lookup eventually completes (or fails, or times out) the Name Resolver 604 signals the transport stack loader 602 through ITsTransportStackNotifySink::OnNameResolved. This method is passed the PLUGUID for the TCP transport and a transport specific connection block that contains the IP address to connect to. In this simple TCPF case no protocol filters are needed so none are passed to the OnNameResolved notification.

NOTE: Transport GUIDs should be known at design/compile time so they will simply be available in the SDK section of the client's header files.

Connection: Control is now transferred back to the Transport Stack Loader 602

Ninth, the transport stack loader 602 loads the appropriate transport component based on the PLUGUID returned by the name resolver 604.

Tenth, the transport component's ITsTransport::Connect method is called passing it the connection block returned by the name resolver. Connect starts an async connect to the IP address in the connection block and signals ITsTransportStackNotifySink::OnConnected when this completes.

Eleventh, the transport stack loader 602 receives the connected notification and fires an event to the client object model to notify any interested components (including plugins) that connection has completed.

Data Flow Portion

Twelfth, the transport stack loader 602 aggregates the transport's ITsTransport interface 618 and upper level components can now make use of the transport API's (defined above under ITsTransport interface) to send and receive data.

Disconnection

Thirteenth, disconnections sourced at the network are reported up from the transport component through the ITsTransportNotifySink, user controlled disconnections (from upper layers) are propagated down to the transport stack loader 602 and eventually to the transport plugin's ITsTransport::Disconnect methods.

Error Reporting

Fourteenth, most methods use COM HRESULT's as return types so errors that happen in the context of a function call are simply returned on the stack and will bubble up the call chain. Errors that might arise during async operations (e.g if a lookup failed or a disconnection happened) can be reported to the transport stack loader through ITsTransportStackNotifySink::OnError.

Reverse Connection

A reverse connection is one where the client is instructed to accept an inbound TCP connection, this could either mean having it connect to an already open socket that some higher level component setup or having it wait on a specified port for a connection.

First, a reverse connection is requested by calling IMsRdpClient::Connect interface requesting a connection to “reverse-tcp: {SOME-OPAQUE-BLOB}”.

Second, the call is propagated down to the transport stack level where ITsTransportStack::StartConnect is called passing it the connection string.

Third, the transport stack parses out the scheme identifier “reverse-connect” from the connection string and looks up the appropriate resolver component for reverse connections.

Fourth, the transport stack loader 602 loads the appropriate Name Resolver by PLUGUID—in most cases this will be a statically linked component so no external DLLs need to be referenced but the support will be there to load in-proc COM objects.

Fifth, the stack loader QueryInterfaces for the name resolver's ITsNameResolver and then calls it's ITsNameResolver::ResolveName method passing it a notification sink interface ITsTransportStackNotifySink 612.

Name Resolution: From this point control is handed to the Name Resolver Component 604.

Sixth, the name resolver 604 parses the scheme specific portion of the connection string {SOME-OPAQUE-BLOB} for validity and to determine what further action should be taken. In this example assume the connection blob specified that the name resolver is to wait on a specified port.

Seventh, the name resolver 604 opens the relevant port and returns control since the wait is to be async.

Eighth, when the port finally accepts a connection (or times out) the Name Resolver 604 signals the transport stack loader 602 through ITsTransportStackNotifySink::OnNameResolved. This method is passed the PLUGUID for the TCP transport and a transport specific connection block that contains the connected socket handle. In this simple TCPF case no protocol filters are needed so none are passed to the OnNameResolved notification.

Connection: Control is now transferred back to the Transport Stack Loader 602.

Ninth, the transport stack loader 602 loads the appropriate transport component based on the PLUGUID returned by the name resolver 604.

Tenth, the transport component's ITsTransport::Connect method is called passing it the connection block returned by the name resolver. Since in this case the name resolver has already returned a connected socket handle the transport immediately calls back ITsTransportStackNotifySink::OnConnected

Eleventh, the transport stack loader 602 receives the connected notification and fires an event to the client object model to notify any interested components (including plugins) that connection has completed.

The remaining portions (e.g DataFlow) are the same as for the TCP forward connect case. In effect the only thing that has changed is that the name resolver setup the connection differently, this may be benficial because it means components, such as a TCP transport, can be re-used in different scenarios.

SIP Type (Pre-Connection Negotiation)

The SIP model illustrates an example where connection to another service followed by some protocol negotiation needs to happen prior to the actual RDP connection. In this case a negotiation happens with SIP to determine what port/machine to connect to.

From the perspective of the client transport plugin infrastructure, arbitrarily complex work can happen within the context of the name resolver's interfaces.

Note: SIP is just one example of a pre-connection negotiation, any arbitrarily complex protocol sequence can be inserted here to, for example navigate through firewalls, or do some QoS type negotiations.

First, a SIP connection is requested by calling IMsRdpClient::Connect interface (documented in MSDN) requesting a connection to “SIP: {SOME-OPAQUE-SIP-SPECIFIC-BLOB}”.

Second, the call is propagated down to the transport stack level where ITsTransportStack::StartConnect is called passing it the connection string.

Third, the transport stack parses out the scheme identifier “SIP” from the connection string and looks up the appropriate name resolver component for SIP connections.

Fourth, the transport stack loader 602 loads the appropriate Name Resolver by PLUGUID—in most cases this will be a statically linked component so no external DLLs need to be referenced but the support will be there to load in-proc COM objects.

Fifth, the stack loader QueryInterfaces for the name resolver's ITsNameResolver and then calls it's ITsNameResolver::ResolveName method passing it a notification sink interface ITsTransportStackNotifySink.

Name Resolution: From this point control is handed to the Name Resolver Component 604.

Sixth, the name resolver 604 parses the scheme specific portion of the connection string {SOME-OPAQUE-BLOB} for validity and to determine what further action should be taken. In this example assume the opaque blob specified the server name for some SIP endpoint.

Seventh, the name resolver opens the relevant SIP port and does whatever negotiations it needs to with the SIP server. Because the name resolver is intended to be async, the SIP resolver has full flexibility to return from the request call and do as much work as it needs to either on some background thread or through posting window messages back to itself.

Eighth, once the SIP negotiation is completed and resolved to an actual server to connect to (or times out) the Name Resolver 604 signals the transport stack loader 602 through ITsTransportStackNotifySink::OnNameResolved. This method is passed the PLUGUID for the TCP transport and a transport specific connection block that contains an IP to connect to. In this simple TCPF case no protocol filters are needed so none are passed to the OnNameResolved notification.

Connection: Control is now transferred back to the Transport Stack Loader 602.

Ninth, the transport stack loader 602 loads the appropriate transport component based on the PLUGUID returned by the name resolver 604.

Tenth, the transport component's ITsTransport::Connect method is called passing it the connection block returned by the name resolver. Once the transport connects to the IP passed in, it fires the ITsTransportStackNotifySink::OnConnected notification.

Eleventh, the transport stack loader receives the connected notification and fires an event to the client object model to notify any interested components (including plugins) that connection is completed.

Most remaining portions (e.g DataFlow) are the same as they are for the TCP forward connect case. In effect the only thing that has changed is that the resolver setup the connection differently, this may be beneficial because it means components such as a TCP transport can be re-used in different scenarios.

HTTPS (i.e. HTTP+SSL Encryption)

The HTTPS scenarios illustrates two new scenarios (1) Adding a protocol filter (in this case HTTP) (2) Setting some client specific property to best suit the transport (in this case selecting SSL encryption).

First, an HTTPS connection is requested by calling IMsRdpClient::Connect interface (documented in MSDN) requesting a connection to “HTTPS://myserver.com:443”.

Second, the call is propagated down to the transport stack level where ITsTransportStack::StartConnect is called passing it the connection string.

Third, the transport stack parses out the scheme identifier “HTTPS” from the connection string and looks up the appropriate name resolver component for SIP connections.

Fourth, the transport stack loader loads the appropriate Name Resolver by PLUGUID—in most cases this will be a statically linked component so no external DLLs need to be referenced but the support will be there to load in-proc COM objects.

Fifth, the stack loader QueryInterfaces for the name resolver's ITsNameResolver and then calls it's ITsNameResolver::ResolveName method passing it a notification sink interface ITsTransportStackNotifySink.

Name Resolution: From this point control is handed to the Name Resolver Component 604.

Sixth, the HTTPS name resolver 604 parses the scheme specific portion of the connection string {myserver.com:443} for validity and to determine what further action should be taken. In this example assume the opaque blob specified the server name and port to connect to.

Seventh, from the transport perspective this is just a TCPF connection so the resolver can aggregate the TCPF resolver to do it's name lookup.

Eighth, once the TCPF name lookup has completed and been resolved to an actual server to connect to (or times out) the Name Resolver signals the transport stack loader through ITsTransportStackNotifySink::OnNameResolved. This method is passed the PLUGUID for the TCP transport and a transport specific connection block that contains an IP to connect to.

Ninth, in this simple case a protocol filter for HTTP is needed so the FILTER_INFO block is filled specifying the PLUGUID for the HTTP filter as follows:

```
    FILTER_INFO FilterInfo;  //block to pass to
OnNameResolved
    FilterInfo.dwFilterFlags = FILTER_INFO_PRE_ENCRYPT;
    FilterInfo.PreEncryptionFilter = PLUGUID_HTTP_FILTER;
```

Tenth, the transport stack loader takes the FILTER_INFO information and directly uses the client's object model API's to load and insert the HTTP filter into the appropriate point in the RDP pipeline.

Eleventh, the last thing the resolver has to do is request a special encryption setting (SSL) so it queries the client's Object Model and sets the desired encryption type to SSL. Client components have full access to the externally exposed object model so they can set or override any property they need to.

Connection: Control is now transferred back to the Transport Stack Loader 2.

Twelfth, the transport stack loader 602 loads the appropriate transport component based on the PLUGUID returned by the name resolver.

Thirteenth, the transport component's ITsTransport::Connect method is called passing it the connection block returned by the name resolver. Since in this case the resolver has already returned a connected socket handle the transport immediately calls back ITsTransportStackNotifySink::OnConnected.

Fourteenth, the transport stack loader 602 receives the connected notification and fires an event to the client object model to notify any interested components (including plugins) that connection has completed.

Data Flow:

Most remaining portions (e.g DataFlow) are the same as they are for the TCP forward connect case. In effect the only thing that has changed is that the resolver setup the connection differently and inserted an HTTP filter into the RDP pipeline.

As data flows down the stack it is passed to the HTTP filter's ITsProtocolFilter::SendData where it can be modified by appending extra HTTP headers inplace within the data buffer.

Hybrid Scenario (Fallback from one Method to Another)

A hybrid scenario is one where one connection type is attempted and failing that, another or a cascade of other methods is tried. Again the plugin host model allows full flexibility for this sort of negotiation as a meta-resolver could be written to the ITsNameResolver interface whose job is to aggregate and manage the flow of control between different child resolvers.

So for example a meta resolver could be written for RAP with the ‘RapResolver’ prefix that could run through a sequence of child resolvers (e.g. SIP, HTTPS, TCP) until it selects an appropriate one for connection and only then return control to the transport stack loader to load an appropriate transport. Consider the following example for purposes of explanation.

First, a connection string of the form “RapResolver://nadima@myhouse” is passed in.

Second, the “RAP” ‘Meta’ resolver is loaded and it loads the SIP resolver to first do some SIP type negotiation that succeeds and after some SIP exchange we resolve to another string e.g. HTTP://foo.bar.com.

Third, the meta resolver proceeds to load the HTTP resolver and hand it the previous string. Any number of resolvers can be attempted and hosted with the ‘Meta’ resolver only returning back to the transport's ITsTransportStackNotifySink when it is ready for a transport to be loaded.

Fourth, once the resolution portion completes successfully, the meta resolver notifies that transport stack loader of the target transport GUID and connection block (including for example an IP address).

The preceding example illustrates attempting multiple different resolvers in sequence, the plug-in architecture however even allows for a resolver to attempt to go all the way to the connection phase and then capture any disconnection errors and re-attempt to resolve/connect.

The autoconnect resolver decides to attempt some alternate form of connection and therefore ‘cancels’ the disconnection event by setting a flag on the notification. This allows it to retry some completely different resolution or transport options. For example, it could try to do some firewall navigation before attempting the new connection.

In the case where the meta-resolver wants to try the actual connection, it can expose an ITsNameResolverNotifySink to get notifications that the transport has failed to connect and can then proceed to try another resolution method by ‘eating’ the notification to prevent it from bubbling up to the rest of the client and causing a UI disconnection.

A simple example of a case which attempts many different types of connections, such as all the way to attempting the actual connection is described below for purposes of explanation.

Fifth, a connection string of the form “AutoConnect://nadima@myhouse” is passed in.

Sixth, the AutoConnect resolver is loaded that tries to first do some SIP type negotiation that succeeds and resolves to an IP.

Seventh, this IP and a transport (E.g. TCP) are passed back to the transport stack loader 602 which loads the TCP transport and attempts the connection.

Eighth, because there are a number of firewalls blocking the route, the transport fails to connect and fires a notification to the transport stack loader's ITsTransportStackNotifySink 612.

Ninth, the transport stack loader calls QueryInterface on the “AutoConnect” name resolver and finds that it exposes an ItsNameResolverNotifySink 620. So the disconnection is immediately relayed to the name resolver 604.

Tenth, the autoconnect resolver decides to attempt some alternate form of connection and therefore ‘cancels’ the disconnection event by setting a flag on the notification. This allows it to retry some completely different resolution or transport options—it could for example try to do some firewall navigation before attempting the new connection.

Exemplary Computing System

FIG. 7 represents an exemplary system or computing environment 700 configured to support an exemplary generically extensible client application. System 700 includes a general-purpose computing system in the form of a first machine 701 and a second machine 702.

The components of first machine 701 can include, but are not limited to, one or more processors 704 (e.g., any of microprocessors, controllers, and the like), a system memory 706, and a system bus 708 that couples the various system components. The one or more processors 704 process various computer executable instructions to control the operation of first machine 701 and to communicate with other electronic and computing devices. The system bus 708 represents any number of several types of bus structures, including a memory bus or memory controller, a peripheral bus, an accelerated graphics port, and a processor or local bus using any of a variety of bus architectures.

System 700 includes a variety of computer readable media which can be any media that is accessible by first machine 701 and includes both volatile and non-volatile media, removable and non-removable media. The system memory 706 includes computer-readable media in the form of volatile memory, such as random access memory (RAM) 710, and/or non-volatile memory, such as read only memory (ROM) 712. A basic input/output system (BIOS) 714 maintains the basic routines that facilitate information transfer between components within first machine 701, such as during start-up, and is stored in ROM 712. RAM 710 typically contains data and/or program modules that are immediately accessible to and/or presently operated on by one or more of the processors 704.

First machine 701 may include other removable/non-removable, volatile/non-volatile computer storage media. By way of example, a hard disk drive 716 reads from and writes to a non-removable, non-volatile magnetic media (not shown), a magnetic disk drive 718 reads from and writes to a removable, non-volatile magnetic disk 720 (e.g., a “floppy disk”), and an optical disk drive 722 reads from and/or writes to a removable, non-volatile optical disk 724 such as a CD-ROM, digital versatile disk (DVD), or any other type of optical media. In this example, the hard disk drive 716, magnetic disk drive 718, and optical disk drive 722 are each connected to the system bus 708 by one or more data media interfaces 726. The disk drives and associated computer readable media provide non-volatile storage of computer readable instructions, data structures, program modules, and other data for first machine 701.

Any number of program modules can be stored on the hard disk 716, magnetic disk 720, optical disk 724, ROM 712, and/or RAM 710, including by way of example, an operating system 726, one or more application programs 728, other program modules 730, and program data 732. Each of such operating system 726, application programs 728, other program modules 730, and program data 732 (or some combination thereof) may include an embodiment of the systems and methods described herein.

A user can interface with first machine 701 via any number of different input devices such as a keyboard 734 and pointing device 736 (e.g., a “mouse”). Other input devices 738 (not shown specifically) may include a microphone, joystick, game pad, controller, satellite dish, serial port, scanner, and/or the like. These and other input devices are connected to the processors 704 via input/output interfaces 740 that are coupled to the system bus 708, but may be connected by other interface and bus structures, such as a parallel port, game port, and/or a universal serial bus (USB).

A monitor 742 or other type of display device can be connected to the system bus 708 via an interface, such as a video adapter 744. In addition to the monitor 742, other output peripheral devices can include components such as speakers (not shown) and a printer 746 which can be connected to first machine 701 via the input/output interfaces 740.

First machine 701 can operate in a networked environment using logical connections to one or more remote computers, such as second machine 702. By way of example, the second machine 702 can be a personal computer, portable computer, a server, a router, a network computer, a peer device or other common network node, and the like. The second machine 702 is illustrated as a portable computer that can include many or all of the elements and features described herein relative to first machine 701.

Logical connections between first machine 701 and the second machine 702 are depicted as a local area network (LAN) 750 and a general wide area network (WAN) 752. Such networking environments are commonplace in offices, enterprise-wide computer networks, intranets, and the Internet. When implemented in a LAN networking environment, the first machine 701 is connected to a local network 750 via a network interface or adapter 754. When implemented in a WAN networking environment, the first machine 701 typically includes a modem 756 or other means for establishing communications over the wide area network 752. The modem 756, which can be internal or external to first machine 701, can be connected to the system bus 708 via the input/output interfaces 740 or other appropriate mechanisms. The illustrated network connections are exemplary and other means of establishing communication link(s) between the first and second machines 701, 702 can be utilized.

In a networked environment, such as that illustrated with system 700, program modules depicted relative to the first machine 701, or portions thereof, may be stored in a remote memory storage device. By way of example, remote application programs 758 are maintained with a memory device of second machine 702. For purposes of illustration, application programs and other executable program components, such as the operating system 726, are illustrated herein as discrete blocks, although it is recognized that such programs and components reside at various times in different storage components of the first machine 701, and are executed by the processors 704 of the first machine.

Although implementations relating to generically extensible client applications have been described in language specific to structural features and/or methods, it is to be understood that the subject of the appended claims is not necessarily limited to the specific features or methods described. Rather, the specific features and methods provide examples of implementations for the concepts described above and below.

1. A client application, comprising:
a modular core component configured to provide a client functionality;
one or more modular non-core components loosely coupled to the core to augment the client functionality and which are not directly referenced by the core component, wherein communication between the non-core components and the core component is facilitated by:
an event system configured to publish events related to the core component and configured to allow the non-core components to receive the published events;
a property system configured to centralize access to properties related to the core component; and,
a plug-in system configured to load non-core components and to facilitate communication between non-core components and the event system and the property system such that the non-core components have a similar level of access to events and properties as is available to the core component.

2. The client application as recited in claim 1, wherein the event system comprises a publication mechanism which effectively decouples a source of an event from a consumer of the event.

3. The client application as recited in claim 2, wherein an individual event comprises an object, and wherein the consumer which receives the object can consume or modify the object.

4. The client application as recited in claim 1, wherein the event system comprises a subscription mechanism through which interested components can request to receive events related to the property.

5. The client application as recited in claim 1, wherein the property system comprises a data driven declaration which defines individual properties and property validation rules associated with the individual properties.

6. The client application as recited in claim 5, wherein the property system is further configured to validate a proposed new property value of an individual property by comparing the proposed new property value to the associated property validation rules.

7. The client application as recited in claim 6, wherein the property system comprises a validation module which is configured to compare the proposed new property value to the associated property validation rules and which is configured to invalidate the proposed new property value in an instance where the proposed new property value fails to satisfy the property validation rules.

8. The client application as recited in claim 1, wherein the plug-in system is configured to select a first sub-group of available pluggable components to achieve a first client application product profile and to select a second sub-group of available pluggable components to achieve a second client application product profile.

9. A computer-readable media comprising computer-executable instructions that, when executed, perform acts comprising:
loading a plurality of modules into a loosely coupled client application having a core component which does not specifically reference the modules; and,
specifying at run time a sub-set of the plurality of modules associated with achieving a specific client application product profile in cooperation with the core component such that the specified modules and the core component generally have a same level of access to properties and events of the client application.

10. The computer-readable media of claim 9, wherein the specifying comprises mapping from the specific client application product profile to the sub-set of modules associated with the specific client application product profile.

11. The computer-readable media of claim 9 further comprising creating a stub for each plug-in which is loaded.

12. The computer-readable media of claim 11, wherein the specifying comprises linking individual plug-ins of the sub-set to a respective stub.

13. A method, comprising:
linking a plug-in through one or more generic extension points to a software application's core without the core specifically referencing the plug-in;
reading one or more properties associated with the one or more generic extension points; and,
subscribing to receive events related to the core at the plug-in, wherein the plug-in and the core have generally equivalent levels of access to the properties and events.

14. The method as recited in claim 13, wherein the reading comprises obtaining the one or more properties from a location other than the one or more generic extension points.

15. The method as recited in claim 13 further comprising requesting to add a new property to the one or more properties.

16. The method as recited in claim 13, wherein the reading comprises reading one or more properties and property validation rules relating to individual properties.

17. The method as recited in claim 13 further comprising requesting to receive a notification of a change to an individual property.

18. The method as recited in claim 13 further comprising requesting to receive a pre-notification of a proposed change to an individual property prior to the change being implemented.

19. The method as recited in claim 18 further comprising responsive to receiving the pre-notification, attempting to affect a value to which the individual property is changed.

20. The method as recited in claim 13 further comprising responsive to receiving an event notification taking an action to affect a user-interface generated by the core.
